(19) United States
(12) Patent Application Publication
(10) Pub. No.: US 2020/0210635 A1
(43) Pub. Date: Jul. 2, 2020

(54) DESIGNING A FORMULATION OF A MATERIAL WITH COMPLEX DATA PROCESSING

(71) Applicants: Newell R. Washburn, Pittsburgh, PA (US); Aditya Menon, Pittsburgh, PA (US); Barnabas Poczos, Pittsburgh, PA (US); Kun Zhang, Pittsburgh, PA (US)

(72) Inventors: Newell R. Washburn, Pittsburgh, PA (US); Aditya Menon, Pittsburgh, PA (US); Barnabas Poczos, Pittsburgh, PA (US); Kun Zhang, Pittsburgh, PA (US)

(21) Appl. No.: 16/488,047

(22) PCT Filed: Feb. 26, 2018
(86) PCT No.: PCT/US18/19736

§ 371 Date: Aug. 22, 2019

Related U.S. Application Data
(60) Provisional application No. 62/600,579, filed on Feb. 24, 2017.
(60) Provisional application No. 62/603,862, filed on Jun. 14, 2017.

(51) Int. Cl. G06F 30/27; G06N 3/04; G06N 3/08; G06F 17/18; G06F 16/23; G06Q 50/04

(52) U.S. Cl. CPC G06F 30/27; G06N 3/0445; G06N 3/0427; G06F 2111/10; G06F 17/18; G06F 16/2379; G06Q 50/04; G06N 3/08

(57) ABSTRACT

A data processing system for processing data records in designing a formulation of a material. A plurality of data records are retrieved and processed by the data processing system to identify a training set of complex system responses for optimizing. The data processing system identifies system variables for varying the system response, identifies underlying physical interactions that determine system responses, performs simulations on simple model systems that probe physical variables, develops parametrized expressions that relate system variables to underlying physical variables, decomposes complex system responses according to the results from simple model systems, re-parametrizes the regression expression for system responses as a function of the underlying physical variables, optimizes the system by searching for global maxima or minima in the resulting function for system responses in terms of system variables, and tests model predictions and integrate results to improve and refine the algorithm via methods of machine learning.

### CLAIM OF PRIORITY

This application claims priority under 35 U.S.C. § 119(e) to U.S. Patent Application Ser. No. 62/603,862, filed on Jun. 14, 2017, and U.S. Patent Application Ser. No. 62/600,579 filed on Feb. 24, 2017, the entire contents of each of which are hereby incorporated by reference.

### GOVERNMENT SUPPORT

This invention was made with Government support under CBET 1510600 awarded by the National Science Foundation. The Government has certain rights in this invention.

### TECHNICAL FIELD

This document describes a system for complex data processing, and more particularly to designing a material formulation, composition of a material, and/or optimization of formulation processes with complex data processing.

### BACKGROUND

Optimization of material formulations and processes is integral to manufacturing but requires balancing of chemical and physical variables. Traditionally this has been accomplished by adapting existing formulations and processes through trial-and-error.

Formulations are complex, multi-component mixtures of chemicals. Examples include paints, personal care products, cosmetics, detergents, and pesticides. Each chemical performs a specific function in the formulation and can be chosen from a broader class of chemicals with similar functions. An example is surfactants, which stabilize chemically dissimilar phases in mixtures. Nonionic surfactants have a structure based on a water-soluble domain, often based on poly(ethylene glycol), and a nonpolar domain, often based on a linear alkane, which comprise the alkyl ethoxylate (AE) class of surfactants. Varying the size of each domain can lead to systematic variations in physical characteristics, such as surface tension or critical micelle concentration, and in function in the formulation, although it can be difficult to predict these effects directly since they can depend sensitively on the other components of the formulation. Traditionally, formulation design either uses previous formulations to guide their development or involves an iterative process in which different chemicals are incorporated at varying concentrations to gauge their effects on formulation performance. It is shown here that HML (hierarchical machine learning) can be used to design formulations based on knowledge of constitutive forces and interactions.

### SUMMARY

This document describes a hardware storage device storing: a plurality of first data records each specifying one or more responses for one or more properties of the composition of the material; a plurality of second data records each specifying one or more parameters and further including, for each of the one or more parameters, a field with one or more values specifying a mapping function that assigns that that parameter to a plurality of variables; a plurality of third data records each specifying at least one of the variables; a plurality of fourth data records each specifying i) a value for each of at least two selected variables implemented in a simulation, and ii) a value of at least one parameter output from the simulation, with the at least one parameter being assigned to each of the at least two selected variables; one or more processors configured to perform operations including: retrieving, from the plurality of fourth data records, a fourth data record specifying particular values of at least two selected variables implemented in a particular simulation and a particular value of at least one parameter output from the simulation; retrieving, from the plurality of second data records, a second data record specifying the at least one parameter that is output; retrieving, from the plurality of third data records, a third data record including at least one of the at least two selected variables assigned to the at least one parameter that is output; replacing a value of a given field in the second data record, with the given field representing a mapping function specified by the second data record, with the replaced value being based on the at least one parameter specified by the second data record, the at least one of the at least two selected variables of the third data record, and the particular values of the at least two selected variables implemented in the particular simulation and the particular value of the at least one parameter output of the fourth data record; based on the replaced value of the field in the second data record, determining updated responses for the one or more properties of the composition of the material; and storing, in the plurality of first data records, the updated responses for respective properties of the composition of the material as a modified set of first data records.

In some implementations, the data processing system includes a sub-system configured to: determine, based on the updated responses, one or more new values for at least one of the properties of the composition of the material; and cause modification of the composition of the material, with the modification being in accordance with the one or more new values for the at least one of the properties.

In some implementations, the data processing system includes a sub-system that determines, based on the updated responses, one or more new values for at least one of the properties of the composition of the material; and an entity that modifies the composition of the material, with the modification being in accordance with the one or more new values for the at least one of the properties.

In some implementations, the data processing system is configured to replace the value of a given field in the second data record comprises applying a machine learning model that uses the at least one parameter specified by the second data record, the at least one of the at least two selected variables of the third data record, and the particular values of the at least two selected variables implemented in the particular simulation and the particular value of the at least one parameter output of the fourth data record. In some implementations, the machine-learning model comprises a recurrent neural network.

In some implementations, determining the updated responses for the properties of the material comprises applying a linear regression model to the value of the field of each of the plurality of second data records.

In some implementations, the data processing system includes a machine learning engine, where the plurality of fourth data records comprise a training set for the machine learning engine. The simulation comprises one or more of physical interactions, digital simulations, and analytical models. In some implementations, the at least one of the two selected variables of the third data record represents a polymeric dispersant formulation. The at least one of the two selected variables of the third data record represents one of a bath concentration, bath material, ink material, printer flow rate, filament packing density ratio, retraction distance, layer height, and needle thickness. In some implementations, the at least one parameter of the second data record represents a functional group of one or more polymeric dispersants, and where a value of the at least one parameter represents a mole fraction of the functional group of one or more polymeric dispersants.

In some implementations, a response specifies one or more of viscosity, osmolality, particle sedimentation, and particle zeta potential. In some implementations, a response specifies one or more of layer fusion, infill value, and stringiness. In some implementations, the given field representing the mapping function comprises a matrix of coefficient values that correlate the at least one parameter to the at least two selected variables. In some implementations, at least one of the updated responses for respective properties of the composition of the material represents a function of the at least one parameter of the second data record. In some implementations, the at least one of the two selected variables of the third data record represents a surfactant formulation. In some implementations, determining the updated responses for the properties of the material comprises applying a symbolic regression model to the value of the field of each of the plurality of second data records.

Concentrated suspensions are formulated with polymeric dispersants to tune rheological parameters, such as yield stress or viscosity. A diversity of dispersants have been developed, but the competing effects on solution and particle interactions have made it impossible to understand their mechanisms of action. In this work, physical and statistical modeling are integrated into a hierarchical framework of machine learning that provides physical insight without requiring large datasets. A library of 10 polymers having similar molecular weight but incorporating functional groups that are commonly found in aqueous dispersants was used as a training set with magnesium oxide slurries. These were screened in simulations in solution and dilute suspension, the results of which were fit to simple generating equations that were parametrized by the average composition of each polymer. Measures of solution viscosity, solution osmolality, particle sedimentation, and particle zeta potential were used as independent variables to express the composition dependence of the slurry yield stress and viscosity. The results of multiple regression were then reparametrized in terms of polymer composition, providing insight into the forces that determine slurry rheology. Excellent fits to both yield stress and viscosity of magnesium oxide slurries were obtained using six regression terms describing solution properties, solution-polymer interactions, and particle-particle interactions. For the majority of the 10 polymer dispersants, it was found that complex correlations resulted in a balance of forces that determined the yield stress but the factors that determined the viscosity were largely independent. The first dispersant predictions of the methodology were synthesized and tested, the results of which will be discussed in the context of learning algorithms. Hierarchical machine learning is an effective methodology for understanding the properties of complex materials with multiple competing interactions without generating large datasets. Further, the data processing system can be used for optimizing formulations and processing in a wide variety of applications.

This document describes a methodology for optimizing complex material formulations and processes that integrates physical and statistical modeling in a hierarchical framework. A novel methodology that integrates physical and statistical modeling is shown to be useful in optimization of complex formulations and processes. A model of machine learning that integrates physical and statistical modeling can optimize material parameters as well as formulation and processing parameters in a single methodology. Here it is applied to additive manufacturing of three-dimensional silicone constructs in which both material variables (e.g. choice of materials), formulation variables (e.g. concentration of materials in solution), and processing variables (e.g. extrusion rate) were modeled.

Schematic representation of the methodology. Complex system responses, such as structural fidelity in 3D printing, are determined by system variables, such as material or deposition parameters. Rather than direct, statistical correlation of responses with variables, the methodology embeds and intermediate layer based on the underlying physics of the system that bridges the bottom and top layers of variables and responses. Integration of the three layers allows for predictive modeling based on sparse datasets.

### BRIEF DESCRIPTION OF THE DRAWINGS

FIG. 1 is a diagram showing an example data processing system.

FIG. 2 shows a schematic representation of hierarchical machine learning methodology.

FIG. 3 shows polymeric dispersants used in the training set.

FIG. 4 shows a schematic representation of connecting the dispersant composition and architecture variables with single-physics responses.

FIG. 5 shows a lasso algorithm for determining the minimal variables to represent the slurry.

FIG. 6 shows parallel plots of slurry yield stress (top) and viscosity (bottom) as a function of solution, particle, and solution-particle interaction variables.

FIG. 7 shows an example implementation including 3D Printing PDMS elastomer in a hydrophilic support bath via freeform

FIG. 8 shows an example implementation of top layer system responses in 3D printing of silicone elastomers.

FIG. 9 shows an example implementation of a middle layer that includes domain knowledge of underlying interactions that control the printing process.

FIG. 10 shows example variables of an example bottom layer of a data processing system.

FIG. 11 shows example plots for determination of optimal physical variables that express printing quality.

FIG. 12 shows system variables found to determine three metrics for print quality.

FIG. 13A shows example system responses determined by the data processing system.

FIG. 13B shows example created 3D printed structures using varying system variable values determined by the data processing system.

FIGS. 14-16 are example flow diagrams showing processes of the data processing system.

FIG. 17 shows an example of a computing system.

Like reference symbols in the various drawings indicate like elements.

### DETAILED DESCRIPTION

Complex materials have multiple competing interactions that result in broad spectra of characteristic energy and timescales, making it challenging to apply computational methods to understand and predict the properties of these systems. These complicated interactions also make high-throughput simulation intractable and has forced reliance on traditional methods of exploring sample sizes with only general theoretical models and empirical constitutive equations to guide development rather than models that provide quantitative predictions of behavior.

The data processing system described herein is able to determine how different variables (e.g., inputs to the process of creating complex materials) contribute to the properties of the complex materials. Machine learning and statistical techniques can be combined into a hierarchical data processing system in which tiers of the hierarchy interact to determine the system response to a system variable input. In some implementations, the data processing system herein includes three tiers. A first tier includes system variables. A second tier includes parameterizations of the system variables of the first tier that are verifiable and adjustable based on single-physics simulations. The third tier includes system response functions that are based on the parameterization of the second tier. The parameterization and the response function can be derived using machine learning and statistical approaches, respectfully, which are described below. The data processing system is able to use small data sets to derive the response functions because the data processing system is able to determine which variables should be adjusted to cause the physical properties of the complex material to have a desired characteristic. The data processing system stores data for each of these tiers in one or more data records, which are used to associate like data types for data manipulation, mapping, etc. and which enables the data associated with one or more of the tiers to be applied to data associated with one or more of other tiers of the data processing system.

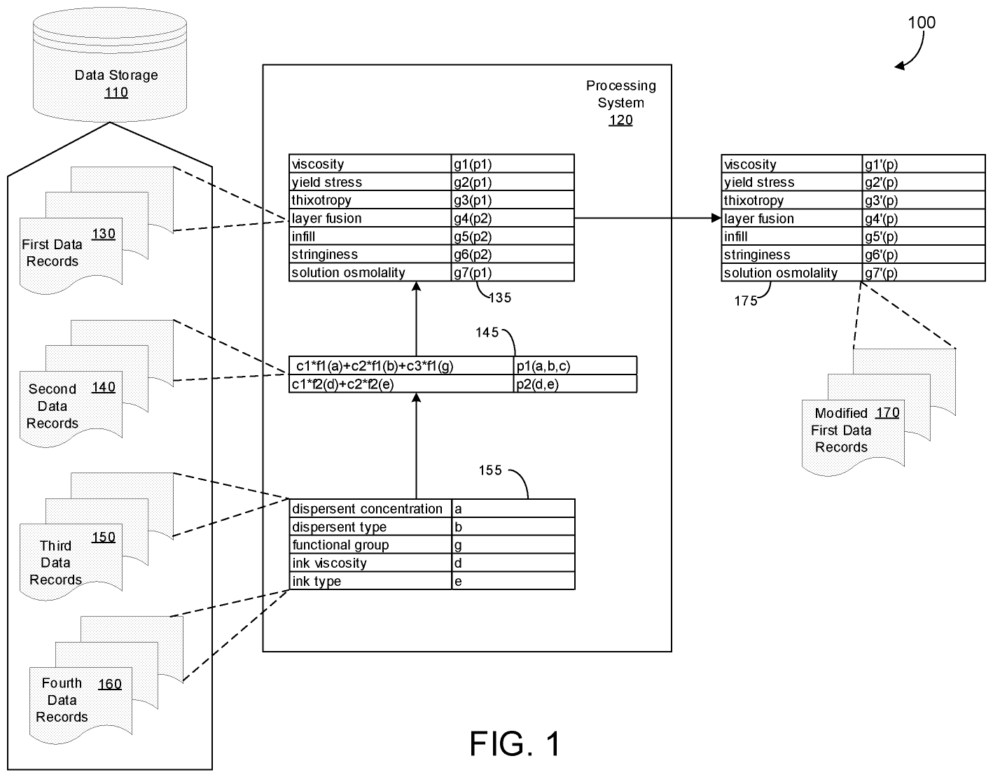

FIG. 1 shows an example of a data processing system 100. The data processing system 100 includes a data storage 110 and a processing system 120. The data storage 110 can include data records, such as a first data record 130, a second data record 140, a third data record 150, and a fourth data record 160. The processing system 120 receives data from each of data records 130-160 and generates new data to create a modified first data record 170.

In FIG. 1, data of each of data records 130-170 are shown as data entries 135, 145, 155 and 175, respectively. Each of data entries 135, 145, 155, and 175 include a number of fields. The data entries 135 show example system responses and their corresponding functions. The data entries 145 show example parameterized system variables and their mapping functions. Data entries 155 show example system variables and their values. Modified first data record 170 includes data entries 175, which include updated system response functions based on data received from fourth data records 160. When new data are received in the fourth data records 160, the system variable entries 155 are updated and new parameter mapping functions are generated at the second (parameterization) tier. Parameter functions can be determined by the data processing system using machine-learning techniques, as described in further detail below. Once the mapping functions of the second tier are updated, statistical methods (e.g., linear regression) are applied to update system response functions of data entries 135 and generate updated system response functions of data entries 175. The updated system response functions can be solved to determine the optimal values for one or more of the system variables of data entries 155. These optimal values are used to generate a complex material, such as a suspension mixture, with the desired physical characteristics.

Suspensions are a ubiquitous class of material that are used as paints, coatings, cosmetics, printable electronics, pharmaceuticals, and agrochemicals that represent a highly complex state of matter. While the viscosity of suspensions ηₛ is determined under dilute conditions by hydrodynamic interactions and is well predicted by the Einstein relation:

ηₛ=η₀(1+2.5ϕ) (1)

in which η₀ is the fluid viscosity and ϕ is the volume fraction of particles, concentrated suspensions have a much more complex viscoelastic properties, determined by fluid characteristics, particle-fluid interactions, and particle-particle interactions. The complexity of their interplay has made it difficult to predict their behavior, and a diversity of empirical approaches have been developed to model these, such as Krieger-Dougherty:

$$\frac{{η}_{s}}{{η}_{0}} = {( 1 - \frac{ψ}{{φ}_{M}} )}^{- [ η ] {φ}_{M}} \qquad ( 2 )$$

in which ϕ_{M} is an estimate of the maximum volume fraction of solid particles and [η] is the intrinsic viscosity. The latter parameter is 2.5 for strictly hydrodynamic interactions but can be 6 or 7 for strongly interacting suspensions, such as cement paste.

Polymeric dispersants are critical for controlling a complex range of phenomena in concentrated suspensions, including development of yield stress, thixotropy, jamming, viscosity discontinuities, etc. Dispersants influence all interactions in suspensions, and the physics of their effects has been studied extensively and summarized clearly. However, while it is possible to use these models to explain the effects of dispersants on suspensions, the inverse problem of using knowledge of these forces to design dispersants has proved exceedingly difficult.

Machine learning is revolutionizing computational analysis and design of materials. These approaches are based on statistical analysis of datasets generated through computation or high-throughput experiments. The goals generally center on optimization of properties, and a diversity of methods have been employed, including entropy minimization studies, trees, neural networks, etc. The relationship between machine learning and condensed-matter theory is complex. Often, additional statistical analysis is used to identify descriptors with physical significance in order to gain insight into the underlying physics. Recent approaches have explored using machine learning to extend theories designed for simple liquids to significantly more complicated systems. However, most of these methods have been developed for computational approaches, and there is clearly a need for methods that are developed to provide deeper physical insight as well as prediction of material properties based on limited data.

Here, a machine-learning framework for investigating suspensions is presented using small datasets based on simple simulations that probe the underlying interactions that combine to determine slurry rheology. The focus is on concentrated aqueous suspensions of MgO, an important material for refractory ceramics that has been also used extensively as a non-setting model for the rheology of hydraulic cement. Rather than directly attempt to correlate the chemistry of large libraries of different dispersants on concentrated-suspension properties, an intermediate tier of “single-physics” simulations are used to connect polymer composition variables with changes in rheology. Through parametrization using basic physical models and regression analysis of these simulations, it is shown that this approach can yield insight into the effects of dispersants on solution forces, particle forces, and solution-particle interactions as well as make predictions of novel dispersants that can reduce slurry yield stress and viscosity. Discussions of uncertainty, causality, and pathways for improving and extending this approach are also presented.

Concentrated aqueous suspensions containing 70% MgO (by mass) were prepared in distilled water. Suspensions were made by first dissolving the polymer in water, followed by gradually adding the MgO with ongoing stirring and shaking to evenly disperse the particles. For suspension rheology, sonication was applied for a 1 hr. after the completion of suspension fabrication and 1 hr. before testing with constant stirring overnight in-between sonication. During the process, the MgO particles shed hydroxide, forming particles with zeta potentials of +20 mV in a fluid with pH of 10, an ionic strength of 2 mM, and estimated screening length of 6.8 nm.

Polycarboxylate ether, polycarboxylate, polystyrene sulfonate, and polystyrene sulfonate ether were prepared via free radical polymerization in a solvent. All monomers, solvents, and initiators were purchased from Sigma-Aldrich.

Adsorption of all the polymers was measured onto MgO by analyzing the total amount of carbon left in the sample before and after adsorption. Each polymer was tested at two different concentrations 0.5 and 1.0 and 5.0 wt. % and mixed with 10 wt. % MgO for an hour and then centrifuged to obtain the supernatant. The supernatant was subsequently diluted and the total organic carbon was measured using a GE lnnovOX TOC analyzer.

Zeta potential of 10 wt. % MgO solution for both 0.5 and 1.0 wt. % added polymer was measured after the solutions were allowed to stir for an hour using a Zeta-sizer (Malvern Instruments).

Osmolality of aqueous solutions of all ten polymers was measured three times each for 0.1, 0.2 and 0.4 g/mL using a vapor pressure osmometer (Wescor 5520). The slope of the osmolality values versus concentration of all the polymer solutions was calculated and multiplied by the molar volume and molality of water to obtain the A₂ coefficient.

Viscosity of both the aqueous solution of the polymer with and without MgO was measured. The viscosity of both solutions was measured as a function of shear rate after 30 s of preshearing at 100^{s-1} to erase the mixing history. The viscosity value at 5^{s-1} was recorded for both and normalized against water and control MgO sample respectively. The MgO pastes were tested at 70% solid content with 0.50 and 1.0 wt. % polymer concentrations.

Sedimentation was measured for all the polymers at three different concentrations 0.05, 0.5 and 1.0 wt. % for 25 wt. % loading of MgO in an aqueous solution. The height of the supernatant was measured every 24 hours for a week. The percentage of sedimentation was calculated using the difference between the measured supernatant values for 24 and 120 h.

A direct application of machine learning could involve generating of order 10²-10³ dispersants (assuming 10 polymer variables were under consideration) and correlating polymer functional groups and architecture with their effects on suspension rheology. In addition to being essentially impossible in current research infrastructure, this approach also does not readily yield mechanistic insight. Given that most published work on dispersants compares 3-5 distinct polymers, methods that facilitate statistical learning with smaller datasets are necessary.

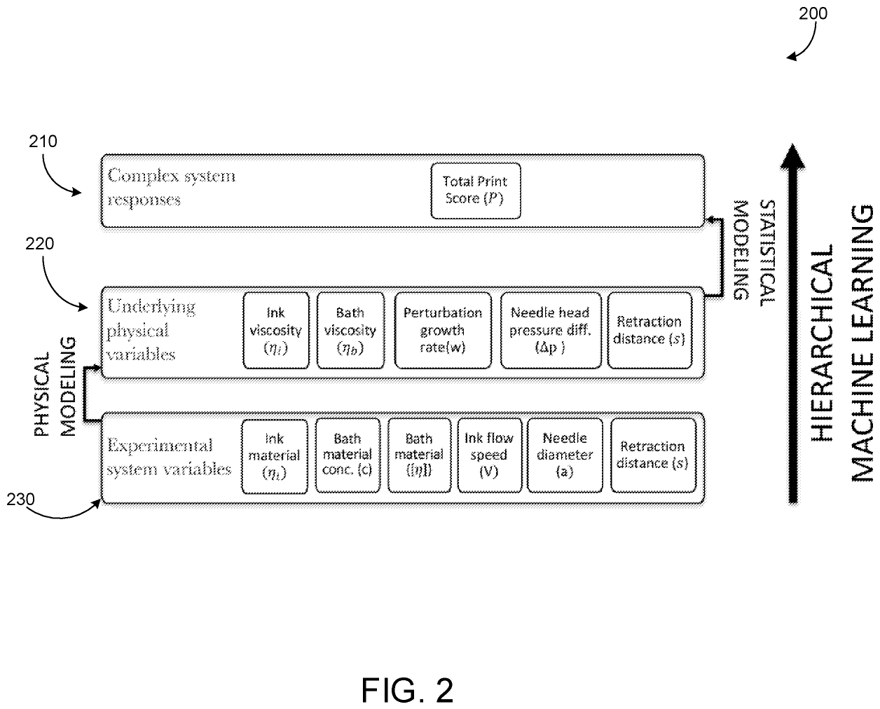

FIG. 2 shows a schematic representation 200 of hierarchical machine learning methodology. The hierarchical machine learning methodology for understanding the effects of polymer dispersants on slurry rheology is shown in FIG. 2. The bottom tier 210 represents controlled variables; in this case, the polymer functional groups and architecture as well as the concentration at which they are added to the suspension. As noted, this is generally a large parameter space but the model is designed to function with sparse coverage.

The top tier 230 represents the properties and responses of the material under investigation. Here, the slurry yield stress and post-yield viscosity are explored as a function of dispersant composition, but the dependence on these variables is exceedingly complex, and only basic trends are understood.

The middle tier 220 connects with both the bottom tier and the top tier, and it serves as a bridge between a large composition parameter space and a complex system properties space. This bridge is based on simple simulations that directly probe single forces or interactions that are thought to determine the responses of the slurry. In this work, the slurry rheology was assumed a function of the solution viscosity and osmolality, and the particle zeta potential and sedimentation. It is not understood a priori how these forces combine to determine the final properties of the slurry, but they form a basis set for expressing changes in slurry responses, the form of which will be determined by regression.

In order to connect the middle tier to the bottom tier, the effects of the dispersants on these four forces were represented by basic physical models that were parametrized by dispersant composition and architecture variables via least squares estimation using a 10-polymer training set. These 10 polymers were chosen to cover the 8 functional groups that were used as the system variables, using polymers that had different combinations of functional groups in either a linear or crosslinked architecture.

In this methodology, the slurry responses are then re-parametrized into functions of dispersant variables using the intermediate layer of single-physics responses as functions of composition. The parametrization of the intermediate tier by composition variables and the decomposition of the slurry responses into these single-physics forces in principle can provide a map of slurry responses as a function of composition, which would otherwise have to be established through probing the effects of large numbers of dispersants. The question that will start to be addressed whether this mapping can provide insight into the mechanisms of dispersant effect in concentrated suspension and how it can be used to design novel, high-performance dispersants. FIG. 2 is described in greater detail with respect to 3D printing applications, below.

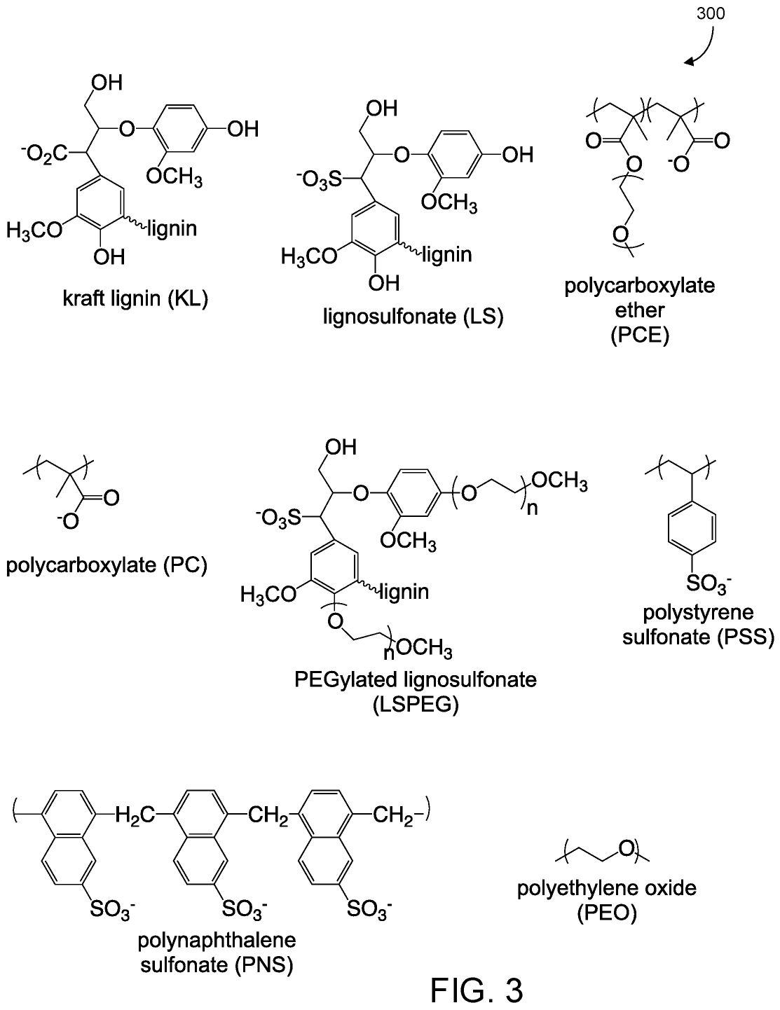

A training set of 10 aqueous dispersants was used as a training set for this methodology, and the names, abbreviations, structures, and zeta potentials of which are shown in FIG. 3. Except for linear PEO, all polymers adopt a negative charge at pH 10.

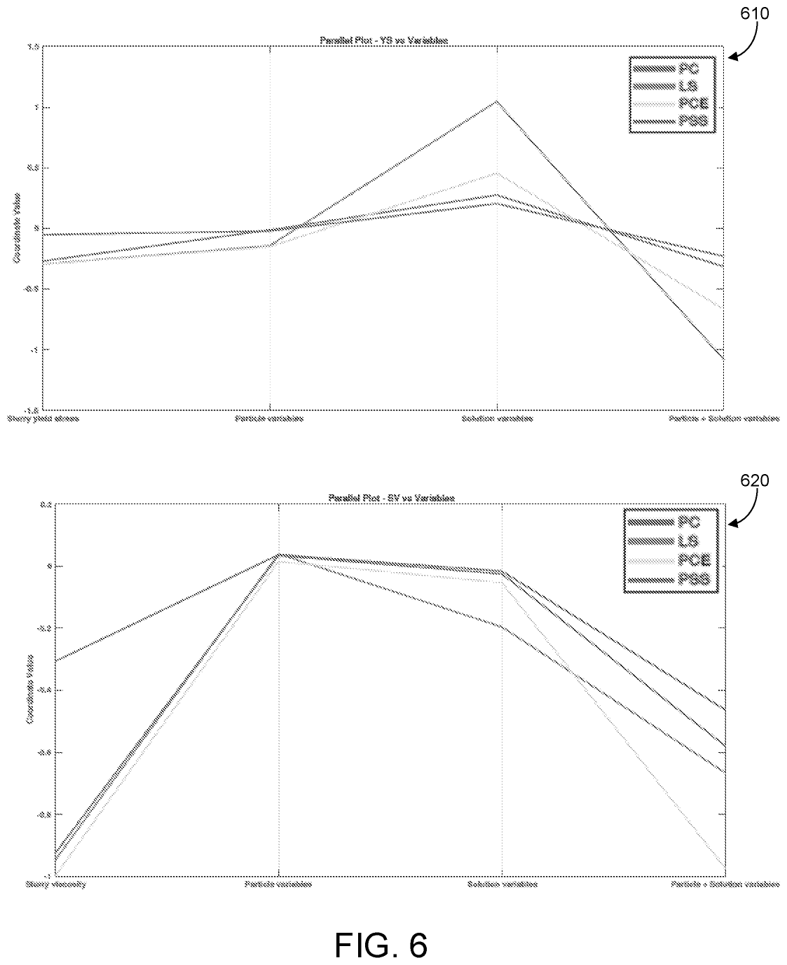

FIG. 3 shows example polymeric dispersants used in a training set 300. The viscosity of MgO slurries was measured as a function of shear rate, and representative responses are shown in FIG. 6. The peak in viscosity, which can be converted to a stress using the shear rate, is associated with yielding. The shear rate at which this peak was observed had only small variation with the dispersant added, but the magnitude decreased for most of the polymers in the training set. As representative examples, incorporation of 1% PCE and LS both resulted in significant reductions of the yield stress. In addition to the magnitude of the yield stress, the viscosity at 5^{s-1} was used as a metric for the post-yield rheology. This shear rate was chosen as providing a representative measure of the post-yield rheology of the suspensions.

It is thought that yielding is determined by dissociation or fracture of a percolating particle network while the post-yield viscosity is thought to be dominated by the dynamic aggregation number of floes in suspension under shear flow. The challenge addressed here is in modeling and predicting how the composition and architecture of the dispersants simultaneously tune solution, particle, and solution-particle interactions in determining these rheological behaviors.

The first step in the model is to connect the bottom tier (polymer composition) with the middle tier (single-physics measurements), which is accomplished by parametrizing the single-physics interactions by the functional groups in the polymers. The goal was to develop simple models for predicting changes in solution viscosity, solution osmolality, particle sedimentation, and particle zeta potential in the actual concentrated suspension as a function of the fraction of each group in the dispersant. The subscript “pol” for each of these variables reinforces that the model is designed to reflect changes due to the presence of the polymer and square brackets “( . . . ]” denote a specific parameter that is scaled to polymer concentration in solution or coverage of adsorbed polymer on the particle surface.

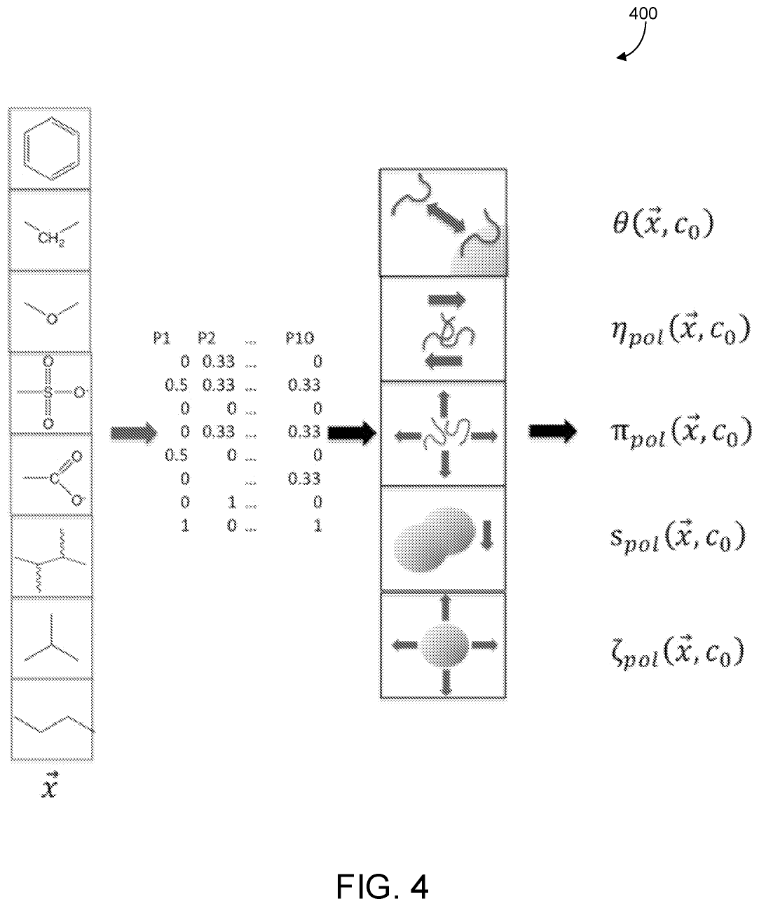

The composition of each polymer was expressed as approximate mole fractions of functional groups assuming a constant molecular weight for each dispersant of 17 kDa, which is the mean for this training set. Architecture was approximated as either crosslinked or linear. These form the eight-element array \vec{x} representing the dispersants, the compositions of which are included in SI. FIG. 4 shows a schematic representation 400 of this process of connecting the dispersant composition and architecture variables with single-physics responses.

While not used directly as a variable for expressing yield stress or slurry viscosity, adsorption is critical for understanding dispersant effects in solution against effects on the particle surfaces.

$$θ ( \vec{x} , {c}_{0} ) = \frac{{c}_{0} {e}^{- U ( \vec{x} ) / kT}}{1 + {c}_{0} {e}^{- U ( \vec{x} ) / kT}} \qquad ( 3 )$$

The interaction potential U was assumed to be that for a single polymer rather than for a monomer, which is the more rigorous approach to polymer adsorption, and this was further parametrized by the fraction of each functional group in \vec{x} using least squares estimation. This generated a map from polymer composition to adsorption energy and then to coverage, albeit an approximate one given the small sample size.

The solution viscosity was parametrized by polymer concentration by assuming the viscosity to vary linearly with concentration of dissolved polymer c₀(1−θ). The specific viscosity reflects differences in contribution due to each polymer, which is always positive relative to the viscosity of pure water and takes the form:

ηₚₒₗ=c₀(1−θ)[ηₚₒₗ(\vec{x})] (4)

The virial coefficient A₂ was measured for each polymer and used to estimate the solution osmolality assuming the molecular weight for each polymer had a constant value of 17 kDa. This can be positive or negative depending on the solubility of the polymer in water at pH 10 but the net osmotic pressure is always positive.

$${π}_{pol} = RT ( \frac{{c}_{0} ( 1 - θ )}{M} + {[ {c}_{0} ( 1 - θ ) ]}^{2} {A}_{2} ( \vec{x} ) ) \qquad ( 5 )$$

The zeta potential ζ for each polymer was measured in solution having pH 10. The zeta potential for the bare MgO particles in solution was found to be +20 mV, and the differential effect on the zeta potential of MgO particles with adsorbed polymer were assumed to take the form:

ζₚₒₗ=c₀θ[ζₚₒₗ(\vec{x})] (6)

Electrosteric interactions between particles with adsorbed polymer are exceedingly complex to measure and model. The sedimentation parameter s defined as the ratio of the particle velocity and the acceleration (s=v/a). The Stokes equation predicts that it varies as d²/ηₛₒₗ where d is the particle diameter and ηₛₒₗ is the solution viscosity. In this approach, s is assumed to be reduced relative to that of a neat MgO solution (denoted by s_{MgO}) due to a combination of a specific electrosteric interaction parameter esₚₒₗ multiplied by the estimated coverage c₀θ(\vec{x}) divided by the estimated solution viscosity. The change in the sedimentation coefficient due to the adsorbed polymer can be positive or negative, depending on how these polymers influence particle-particle interactions.

$$s = {s}_{MgO} - {s}_{pol} = {s}_{MgO} - \frac{{c}_{0} θ ( {es}_{pol} ( \vec{x} ) ]}{{η}_{{H}_{2} O} + {c}_{0} ( 1 - θ ) [ {η}_{pol} ( \vec{x} ) ]} \qquad ( 7 )$$

The results of decomposing the specific polymer interaction parameters ([nₚₒₗ(\vec{x})], A₂(\vec{x}), [ζₚₒₗ(\vec{x})], [esₚₒₗ(\vec{x})], θ(\vec{x})) accorss the composition array \vec{x} functional-group contributions to each interaction, which are summarized in SI. The concentration dependence is captured in changes in the coverage θ; all other interaction parameters were assumed to be concentration-independent.

While it can be difficult to identify trends across these parameters from reviewing the entries in this matrix, the Pearson product coefficients can provide a measure of the correlations between single-physics interactions across the functional groups.

TABLE 1
Correlations between single physics interactions
across functional groups

| | [ηₚₒₗ(\vec{x})] | A₂(\vec{x}) | [ζₚₒₗ(\vec{x}) | [esₚₒₗ(\vec{x})] | θ(\vec{x}) |
|---|---|---|---|---|---|
| [ηₚₒₗ(\vec{x})] | 1.00 | −0.59 | −0.45 | −0.93 | −0.14 |
| A₂(\vec{x}) | −0.59 | 1.00 | 0.39 | 0.36 | −0.22 |
| [ζₚₒₗ(\vec{x}) | −0.45 | 0.39 | 1.00 | 0.54 | 0.06 |
| [esₚₒₗ(\vec{x})] | −0.93 | 0.36 | 0.54 | 1.00 | 0.36 |
| θ(\vec{x}) | −0.14 | −0.22 | 0.06 | 0.36 | 1.00 |

It should be noted that a value of 1 represents a perfect positive correlation, that of −1 represents perfect anti-correlation, and 0 represents uncorrelated variables. The magnitude of the coefficient does not provide information on the magnitude of the effect, only the strength of the correlation. A coefficient with magnitude greater than ca. 0.50 suggests significant correlations between these interactions.

As a function of composition, the polymer contribution to viscosity was found to be anti-correlated with A₂. This was primarily associated with hydrophobic alkyl or aromatic groups, which are thought to penalize solvent interactions leading to a reduction in A₂ but an increase in viscosity through reversible associations. Polymer contributions to viscosity were also anti-correlated with the zeta potential and electrosteric parameter derived from the sedimentation results, both of which were attributed to the solubilizing effects of carboxylate and sulfonate groups that reduce viscosity but increase the magnitude of the surface charge when adsorbed onto MgO particles. (Pendant PEG chains may play a similar role in increasing solubility and the electrosteric interaction.) Interestingly, the viscosity was essentially uncorrelated with adsorption, which may be due to the competing effects of hydrophobic and charged groups that both contribute to interactions with MgO surfaces.

As expected from analysis of the polymer contribution to viscosity, the A₂ parameter was positively correlated with both zeta potential and the electrosteric parameter, although the strength of the correlation was modest. Similarly, A₂ was found to be anti-correlated with adsorption, although the value of this was weaker than expected (−0.22).

While the zeta potential and electrosteric parameter are both modeled as having coulombic components, the correlation of 0.54 was weaker than anticipated, which may be due to the strong effects of steric interactions in the latter. It may also be due to the poorly defined nature of the electrosteric parameter. While sedimentation is a very accessible measurement, deriving an interparticle interaction parameter from sedimentation certainly requires a more thorough treatment than undertaken as a part of developing this methodology.

In this methodology, the complex system responses yield stress and slurry viscosity are functions of the single-physics interactions. Here, the changes in yield stress and viscosity (both usually negative) due to the addition of polymer were fit via to functions of the single-physics interactions. While it is possible to use more complex, empirical equations that have been shown to fit data well, in this preliminary work only functions based on the 14 first- and second-order terms (and the first cross-terms) of (ηₚₒₗ, πₚₒₗ, ζₚₒₗ, sₚₒₗ) were considered.

The standard linear regression model can be formulated as minₓ|y−Ax|₂², where A is a given design matrix (inputs), y denotes output vector, and x is the parameter to be optimized The Lasso algorithm¹⁴ extends the standard linear regression to minₓ|y−Ax|₂²+λ|x|₁, where λ≥0 is a real parameter and |x|ₚ is the p-norm of a vector. One can prove that if the regularizer parameter is large enough, then in the optimal solution of the Lasso problem only a few components will be active, the others will be zeros. In the λ→0 case, Lasso is the standard linear regression, while in the limit case the optimal solution is x=0, that is, all components are zero. This regularization acts as a feature selection method: depending on the value the method selects only a few active features, which in turn can help avoid overfitting.

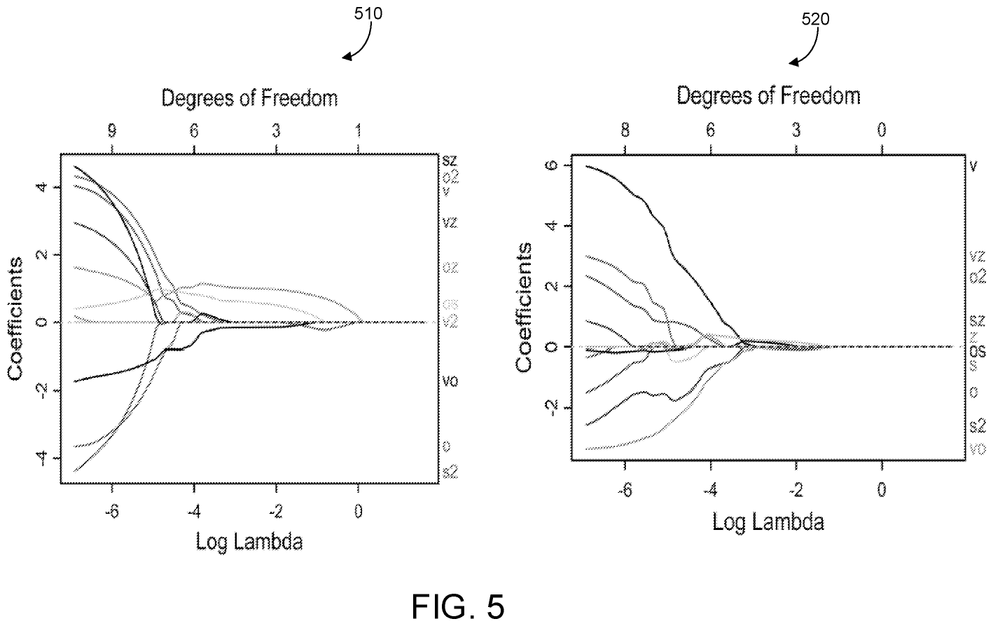

The results of Lasso algorithms are plotted separately in graphs 510, 520 for slurry yield stress and viscosity in FIG. 5. Starting with the full basis set of 14 variables, the Lasso iteratively decrements regression coefficients through varying the λ parameter. Cross-validation was then performed at λ=0.03 (ln 0.03=−4.6) in order to identify the minimal basis set that provides greatest predictive capabilities with the smallest number of variables. For most systems to which the Lasso is applied, these curves are smoother and decrease or decrease monotonically. The non-smooth curves obtained here are attributed to the small sample size, but the results are consistent.

FIG. 5 shows graphs 510, 520 showing a Lasso algorithm for determining the minimal variables to represent the slurry yield stress (left) and viscosity (right) as a function of polynomials in the basis set (ηₚₒₗ, πₚₒₗ, ζₚₒₗ, sₚₒₗ).

Lasso and cross-validation resulted in the following functions for Δτ_{y} and Δηₛ:

Δτ_{y}=1.28ηₚₒₗ+0.16πₚₒₗ²−0.86ηₚₒₗπₚₒₗ−0.63sₚₒₗ²+0.39Πₚₒₗζₚₒₗ+0.26ηₚₒₗsₚₒₗ (8)

Δηₛ=0.08πₚₒₗ²−0.21ηₚₒₗπpol+1.10πₚₒₗζₚₒₗ+0.70Πₚₒₗsₚₒₗ+0.15ζₚₒₗsₚₒₗ (9)

Each term in these expressions relates to the differential effects of given variables on slurry properties relative to the unmodified slurry yield stress τ_{MgO} and viscosity η_{MgO}, respectively.

For the yield stress prediction, the polymer contribution to the viscosity was normalized to [0,1] so the positive coefficient predicts that the solution viscosity increases the yield stress with the largest coefficient (1.28) for the variables, indicating the it has a strong effect on yield stress. This may be due to the viscosity providing a characteristic timescale for stress relaxation but further analysis of this question is required. The osmotic pressure contribution was also normalized to [0,1] and was positively correlated with the change in yield stress although the smaller coefficient (0.16) suggested its effect was weaker. Interestingly, a cross-term between the polymer contribution to the viscosity and the osmotic pressure had a negative coefficient (−0.86), which served to counterbalance the increases in yield stress that the other two solution-based terms contributed.

The only strictly particle-associated term in the regression analysis of changes in yield stress was a term that went as the square of sedimentation parameter. The magnitude of sₚₒₗ was associated with polymer effects that changed the sedimentation coefficient relative to that of a pure MgO suspension—reducing it for 8 of the 10 polymers in the training set. The negative coefficient indicates that this interaction results in a decrease in yield stress, which is consistent with the intuition that electrosteric interactions can destabilize particle-particle interactions in percolating networks in addition to preventing aggregation.

Two terms that involved coupling between solution and particle parameters were identified in the regression, and both functioned to decrease the yield stress due to the negative values for the zeta potential and most electrosteric parameters. The product of polymer contributions to osmotic pressure and zeta potential formed a coupled variable, as did the product of polymer contributions to viscosity and sedimentation. The physical basis for these is unclear—polymer solutions are thought to interact with adsorbed polymers via osmotic forces that can stabilize or destabilize suspended particles, and these variables could be a manifestation of these types of interactions.

In contrast with the prediction for changes in yield stress due to the dispersants, the changes in the slurry viscosity were almost entirely due to solution or solution-particle terms with only a single particle contribution associated with the cross-term based on zeta potential and sedimentation that contributed increases in the viscosity but with a relatively small coefficient (0.15). The solution contributions to changes in viscosity either had small positive coefficients (πₚₒₗ²) or a negative contribution due to the cross-term based on viscosity and osmotic pressure. The two solution-particle terms, having the same form as found in the expression for changes in the yield stress, had larger coefficients and appeared to dominate reductions in slurry viscosity.

While the individual contributions of the interactions differ in the expressions for the changes in slurry yield stress and viscosity, the terms in both equations can be divided into three groups: solution properties due to viscosity or osmolality, particle properties due to zeta potential or sedimentation interactions, and coupling between fluid and particle variables. The correlations between these three variable groups can be assessed using the Pearson product-moment correlation coefficients. The values for the yield stress and viscosity responses are seen in Table 2.

TABLE 2
Sample values for yield stress and viscosity.

| | | | Solution- | |
|---|---|---|---|---|
| Δτ_{y}/Δηₛ | Solution | Particle | Particle | θ |
| Solution | 1.00/1.00 | −0.82/−0.09 | −0.47/−0.12 | 0.09/0.67 |
| Particle | −0.82/0.07 | 1.00/1.00 | 0.53/−0.28 | 0.23/0.07 |
| Solution- | −0.47/−0.12 | 0.53/−0.28 | 1.00/1.00 | −0.26/−0.19 |
| Particle | | | | |
| θ | 0.09/0.67 | 0.23/0.07 | −0.26/−0.19 | 1.00/1.00 |

For the yield stress, it is interesting that the composite solution variable is anticorrelated with the particle and solution-particle variables, and the particle and solution-particle variables are moderately correlated. None of these variables is significantly correlated with adsorption.

For the viscosity, the solution variable is essentially uncorrelated with the particle and solution-particle variables but strongly correlated with adsorption, while the particle and solution-particle variables are weakly anti-correlated. This suggests that in tuning the composition, the polymer effects on viscosity act independently. However, for controlling the yield stress, the effects of the composition variables are manifested across the solution, particle, and particle-solution interface. While variable selection using Lasso algorithms is described above, other regression models (e.g., ridge regression, elastic net regression, etc.) can be used either in combination with or instead of the above-described methods.

In addition to selecting optimal variables (e.g., by ridge regression or Lasso as described above), there are methods for choosing the best mathematical equations to model the system. Symbolic regression enables selection of response functions when knowledge of the domain of the system (e.g., material, formulation, etc.) is limited or non-existent.

The solution, particle, and solution-particle effects can be captured in a parallel plot for four representative polymers to illustrate the effects of particular functional groups or architectures. This is shown in FIG. 6 in plots 600 for PC, PCE, PSS, and LS for contributions to both the yield stress and viscosity.

The value of the change in slurry yield stress or viscosity due to a given polymer is shown to the farthest left in these plots, and the sums of the respective solution, particle, and solution-particle terms are plotted for each polymer as separate categories. For example, to calculate the solution contribution to the yield stress for a given polymer, the values of ηₚₒₗ and πₚₒₗ were calculated and were then used to calculate 1.28ηₚₒₗ+0.16πₚₒₗ²−0.86ηₚₒₗπₚₒₗ. In both the yield stress and viscosity lots, it is seen that the solution and solution-particle terms make the largest contributions to the decrease due to the polymer, which is at odds with the accepted view that the primary function of dispersants is controlling particle-particle interactions. However, for the Δτ_{y} parallel plot, the anti-correlations between solution and solution-particle variables are evident. Indeed, for the four polymers plotted here, the decreases due to the solution-particle interactions are nearly offset identically by the increases due to the solution variable, and the net change in yield stress is in fact due to the particle forces.

In contrast, in the Δηₛ plot, no such anti-correlations are present and the decreases due to the composite solution-particle contribution are not systematically offset by either the solution or particle contributions. This is consistent with the view that the dynamics at solution-particle interfaces are critical for determining aggregation numbers and the post-yield viscosity.

In comparing PC to PCE, which are both based on linear alkyl carboxylate polymers, the difference in functional groups is the incorporation of pendant PEG chains in the latter. This causes a decrease in particle interaction terms that decrease the yield stress, presumably due to the increase in steric interactions imparted by the PEG chains. (The calculated electrosteric parameter was 10-fold higher for PCE than Pc.) As already discussed, increases in yield stress due to solution terms were largely offset by decreases due to solution-particle interactions. In comparison, PSS is a linear sulfonated alkyl-aromatic polymer, which has minimal net effects on particle variables and the net decrease in yield stress was due to the solution-particle interaction terms more than compensating for the increases due to solution terms. Finally, LS is a crosslinked sulfonated alkyl-aromatic polymer that displayed the largest positive contribution due to solution variables and negative contribution due to solution-particle variables that are imparted by the crosslinked architecture. It is interesting to note that LS had an intermediate value of A, but the second highest value of [ηₚₒₗ], suggesting that this combination of solution properties was responsible for the model predicting the extreme values of solution and solution-particle contributions.

In the Δηₛ plot, PC imparts only a modest decrease in post-yield viscosity while PCE, PSS, and LS all have comparable effects. Interestingly, all four polymers have very small effects on particle variables that affect viscosity, but strong differences in solution and solution-particle interaction variables are observed, with PCE (the only polymer in this group engineered to have increased steric interactions) having the most negative term.

Continuing in reference to FIG. 6, the parallel plots of slurry yield stress (plot 610) and viscosity (plot 620) as a function of solution, particle, and solution-particle interaction variables are shown. While the approach outlined here makes numerous oversimplifications in order to create a tractable methodology, the results appear to largely align with basic intuition for these complex systems but offers clarity in terms of decomposing the effects into physically meaningful contributions. Thus, the model naturally provides physical insight, in contrast to tradition machine learning approaches for analyzing large datasets. However, the real test of the methodology comes in applying learning algorithms and testing its predictions for optimized dispersants.

Integration of the tiers in the model results in reparametrization of the expressions for changes in slurry yield stress and viscosity in terms of polymer composition and concentration:

Δτ_{y}=Δτ_{y}(\vec{x}, c₀) (10)

Δηₛ=Δηₛ(\vec{x}, c₀) (11)

Minimization of these functions with respect to composition and concentration provides specific targets for the molecular engineering of dispersants in this suspension system. It should be noted that despite the discrete nature of the training set, the parametrization done in the middle tier of the methodology results in continuous functions of the composition variables.

The following compositions of Table 3 were predicted to minimize the slurry yield stress:

TABLE 3
Predictions of dispersant compositions that minimize slurry yield stress.

| | Sulphonate | Carboxylate | PEG | Alkyl | Aromatic | PEO | Crosslinked | Linear |
|---|---|---|---|---|---|---|---|---|
| Polymer | 0.0110 | 0.0060 | 0.0248 | 0.7436 | 0.2145 | 0.0002 | 0 | 1 |
| 1 | | | | | | | | |
| Polymer | 0.1260 | 0.0000 | 0.0003 | 0.8741 | 0.0000 | 0.0000 | 1 | 0 |
| 2 | | | | | | | | |

Polymer 1 would not be expected to be soluble in water do to the preponderance of alkyl and aromatic groups, but Polymer 2 was synthesized via ATRP to form a crosslinked star copolymer based on sulfonate methacrylate and dimethacrylate. This architecture has been shown to have high interfacial activities, and the composition resembles that of LS but without the aromatic content. However, the measured yield point on the viscosity plot was 261 Pa·s, which is approximately 50% lower than that of pure MgO suspensions (478 Pa·s) but still significantly higher than the value measured for LS of 4 Pa·s.

The reason for the discrepancy between model and simulation could be the generic term “crosslinked” used to represent nonlinear polymer architectures. The star copolymer synthesized is expected to have an approximately spherical shape in solution, but the LS used in this work is thought to have a sheet-like structure. While significant advances in polymer chemistry have been reported, synthesizing two-dimensional macromolecular architectures remains a challenge. Other candidate dispersants may be synthesized that are predicted to minimize the rheological parameters while refining the model to incorporate a broader range of architectures.

The strength of the data processing system is the use of sparse datasets to connect vast parameter spaces with complex responses spaces. However, it is dependent on the models used to connect the tiers in the hierarchy. While the decomposition of slurry yield stress and viscosity into contributions from the single-physics interactions has provided interesting interpretations into how dispersants function in concentrated suspensions, parametrizing the single-physics interactions by a sum of polymer functional groups is clearly not adequate based on the small number of polymers used in this approach. Furthermore, it is not clear whether the integrated model is capable of predicting combinations of parameters that were not included in the training set. An example is the incorporation of both carboxylate and sulfonate functional groups in a single dispersant in the training set. Expanding to larger training sets with greater diversity in dispersant chemistry will improve the predictive capabilities, but most QSAR approaches require at least 103 samples, and the significant uncertainty in the model predictions needs to be understood better.

Learning can be based on probing the response spaces at all the different levels in the hierarchy. While minimization of Δτ_{y}(\vec{x}, c₀) and Δηₛ(\vec{x}, c₀) is the goal for dispersant design, insight into the validity of polymer-composition parametrization can be explored through measurement and testing of mid-tier variables, such as predictions of ηₛₒₗ(\vec{x}). Furthermore, there are numerous semi-empirical models for relating slurry properties to composition and constituent interactions that fit the data quite well and could be adapted for the regression fitting instead of the polynomial in the basis set (ηₚₒₗ, πₚₒₗ, ζₚₒₗ, sₚₒₗ). A generalized model to predict the viscosity of solutions with suspended particles is thus developed. This approach could embed greater information content into the methodology and better leverage the large body of research into the rheology of suspensions.

Finally, a critical aspect of learning is the identification of causal rather than associative variables. Causal variables need to be identified in both the bottom and the middle tiers of the model. In the bottom tier, active learning is a powerful approach to semi-supervised machine learning that requires using the model to predict which dispersants to test next.

Other implementations of the data processing system are possible. For example, in another demonstration of the machine learning methodology, a printing technique was used called freeform reversible embedding (FRE) where liquid silicone elastomers are 3D printed within a bath that acts as a support to prevent gravity-driven collapse of the silicone “ink” during additive manufacturing. The bath is a Bingham fluid, yielding as a viscoelastic liquid to the extruder and thereafter sustains the silicone ink as a viscoelastic solid. Once stacking of the layers completes, the printed structure is then crosslinked by heat curing or ultraviolet light, and then removed from the bath.

Freeform reversible embedding of suspended hydrogels (FRESH) is a 3D printing technique developed for soft materials where liquid precursors are injected into a support bath that prevents gravity-driven flow of the “ink” during additive manufacturing. The bath is a Bingham fluid, yielding as a viscoelastic liquid to the extruder but recovers rapidly to support the green form during printing. The bath chemistry is designed to allow for facile, stimulus-responsive release, generally through thermoreversible melting of the hydrogel once the part has been cured.

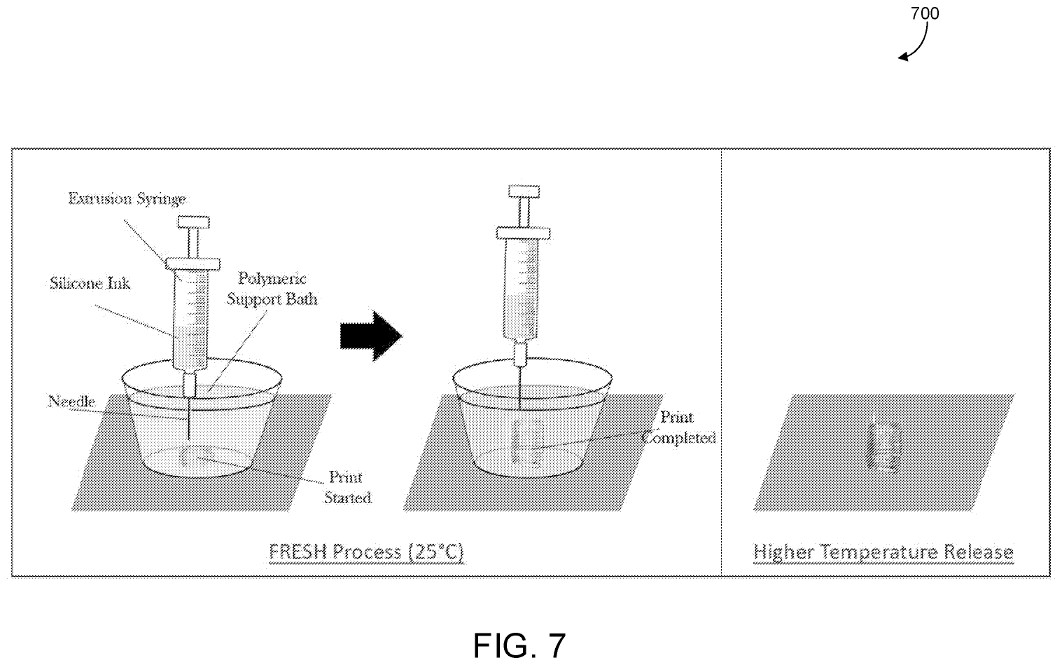

FIG. 7 shows an example implementation 700 including 3D Printing PDMS elastomer in a hydrophilic support bath via freeform. A low-viscosity polymer precursor is extruded into an aqueous medium that behaves as a Bingham fluid with a yield stress and high post-yield viscosity. The printing speed is controlled by the pressure drop across the needle and the velocity of the needle assembly through the bath. Following curing, the printed form is released by melting the bath.

The interaction of the nozzle with the bath is complex, especially at high shear rates associated with rapid printing. Motion of the nozzle generates an air gap at the bath surface, and localized fluidization of the hydrogel occurs near the tip, both of which can influence feature resolution and interlayer connectivity. The ink is commonly a Newtonian fluid with a viscosity much lower than that of the bath (even in the post-yield state) and viscosity mismatch can result in fingering instabilities that can impact printing fidelity. The recovery time of the bath depends sensitively on the structure and chemistry of the constituent hydrogel, which is often based on hydrated, reversibly associating polymer granules for which the yield stress, viscosity, and recovery time following cessation of shear all depend sensitively on both polymer chemistry and polymer concentration. The processing variables of nozzle diameter, volumetric flow rate of the ink, nozzle velocity, and retraction distance, which prevents ink overflow into the bath, can all have complex effects on printing. Global optimization of the FRESH printing method requires simultaneous tuning of all these variables to optimize print fidelity and speed.

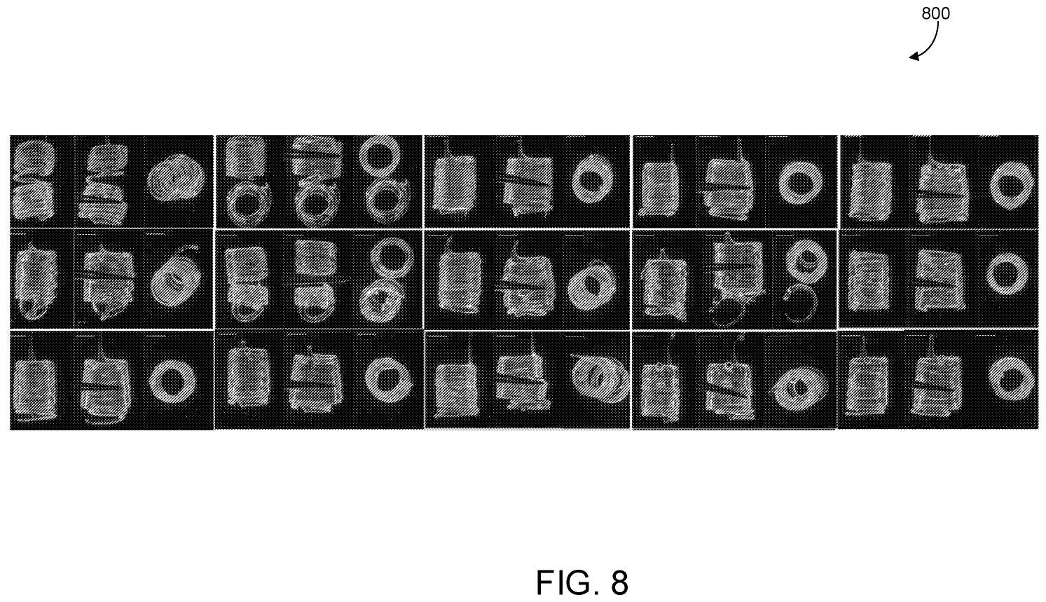

Reversible embedding is enabled. FIG. 8 shows an example implementation 800 of top layer system responses in 3D printing of silicone elastomers. Printing fidelity depends on numerous system variables. FIG. 8 shows various run samples, rated from lowest scores to highest scores. The data set, containing around 56 runs, is from 3D printing of a hollow tube. Each of the response variables, including ‘Layer fusion’ (adhesion between printed layers), ‘Infill’ (bulging of the material inside the hollow cube) and ‘Stringiness’ (adhesion of the first layers that often overhang like strings) is scored from 0-10 with total score being a sum out of 30.

A critical component of the HML (hierarchical machine learning) methodology is determining the range over which the system variables can be set and still achieve optimal responses. In complex systems, competing interactions make it impossible to reach performance metrics based on maximization of a small number of variables. Rather, optimal solutions involve balancing variables within ranges, and in these systems the synergies between variables lead to optimization.

Sensitivity analysis was performed to establish ranges over which system variables could be set. These results were also the basis for determining the set of underlying physical processes and interactions that were embedded in the middle layer of the HML algorithm. In exploring the dependence of print fidelity on needle diameter, it was observed that needles with narrower inner diameter resulted in fluid instabilities that led to breakup of the PDMS ink into droplets.

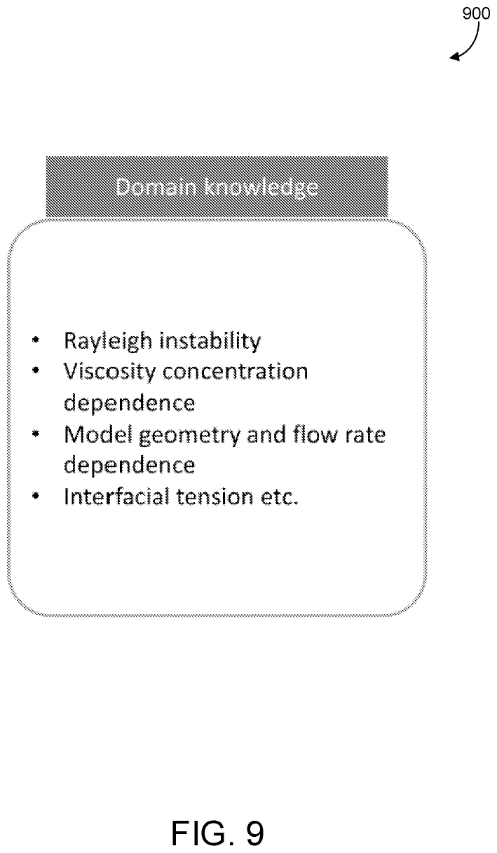

FIG. 9 shows an example implementation 900 of a middle layer that includes domain knowledge of underlying interactions that control the printing process. Example associations between variables include Rayleigh instability, viscosity concentration dependence, model geometry and flow rate dependence, interfacial tension, etc.

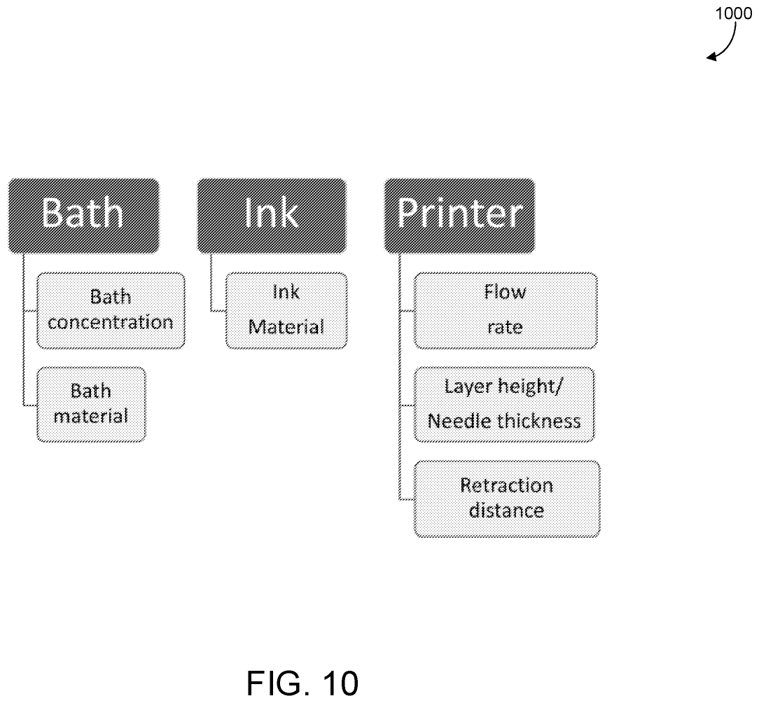

FIG. 10 shows example variables 1000 of an example bottom layer of a data processing system. Discrete and continuous variables can be identified. For example, variables can include bath concentration and bath material, ink material, printer flow rate, filament packing density ratio, retraction distance, and model geometry including layer height and needle thickness.

The data set used to train the algorithm contained 38 prints of a hollow cylindrical tube (D=10.8 mm, H=13.5 mm) composed of vertically aligned loops of PDMS. Based on a standard rubric, each print was scored out of 10 possible points in 3 categories: ‘layer fusion’ which is characteristic of the adhesion between print layers, ‘stringiness’ which is the adhesion, specifically for the first few layers that hang loosely in case of a bad score, and ‘infill’ which is the bulging or collapse of material around the middle layers of the cylindrical form. The system response to be optimized with the HML model is a sum of these three components of the rubric with a maximum score of 30. Print rate can be explored as a parameter by setting ranges for ink flow rate and nozzle velocity then allowing the algorithm to identify the maximum print rate that retains fidelity.

Connecting the bottom layer of the HML model with the middle layer requires parametrization of the underlying physical forces and interactions by the system variables. This was accomplished using physical models that capture the underlying forces then determining necessary coefficients in the models. In modeling the FRESH process, the ink viscosity (ηi) and retraction distance (s) were taken as pure numerical variables but the rheological properties of the bath (ηb), instability of the extruded ink in the bath medium (w), and pressure dependence of the ink flow rate (Δp). The functions for these are shown in Table 4, below:

TABLE 4
Representative functions for physical models

| | |
|---|---|
| Huggin's Equation⁴ | η_{b} =1 + [η]c + k_{H} [η]² c₂ |
| Fluid thread breakup in higher external viscous medium⁵ | $w = \frac{σ ( 1 - {k}^{2} {a}^{2} )}{( 2 a {η}_{b} ) ( {k}^{2} {a}^{2} + 1 - {k}^{2} {a}^{2} {K}_{0}^{2} ( ka ) \text{/} {K}_{1}^{2} ( ka ) )}$ |
| Hagen-Poiseuille law | $V = \frac{Δ {pR}^{2}}{8 {η}_{i} l}$ |

The viscosity of the bath was variable and was modeled based on a simplified form of Huggin's equation, ignoring the quadratic and higher order terms where viscosity only depends on the concentration and intrinsic viscosity of the polymeric bath material.

To model fluid-thread breakup, a Rayleigh-Plateau instability was incorporated in which perturbations develop on the free surface of the fluid, growing quickly over time and resulting in instable fluid flow for viscous fluids. The perturbation growth rate becomes only a function of the initial radius of the fluid thread, the perturbation wavelength, the surface tension of the thread, the viscosity of the external environment, and the second order Bessel functions of the second kind. In our model, it was assumed that the perturbation wavenumber remains constant for all conditions, which was represented as a unit quantity here. The interfacial tension values for different PDMS inks generally range between 20-30 mN/m, and the average was used. The final independent variable was the pressure used to drive flow of the ink. Based on Hagen-Poiseuille law, the flow rate was assumed to be directly proportional to the pressure difference and needle size and inversely to ink viscosity and length of the needle.

In HML, the system responses are expressed in terms of the underlying physical variables, the form of which is determined through statistical learning. Here, regularized regression was used to identify the underlying physical variables and their combinations that most strongly determine system responses. The simplest representation of variable coupling was to use the products of the underlying variables in the middle layer.

Based on five underlying physical forces or interactions and ten cross-terms between them, Lasso with “leave one out” cross-validation (LOOCV) were used to identify an optimal variable set that balanced modeling of the data in the training set with predicting the responses to new data in a test set.

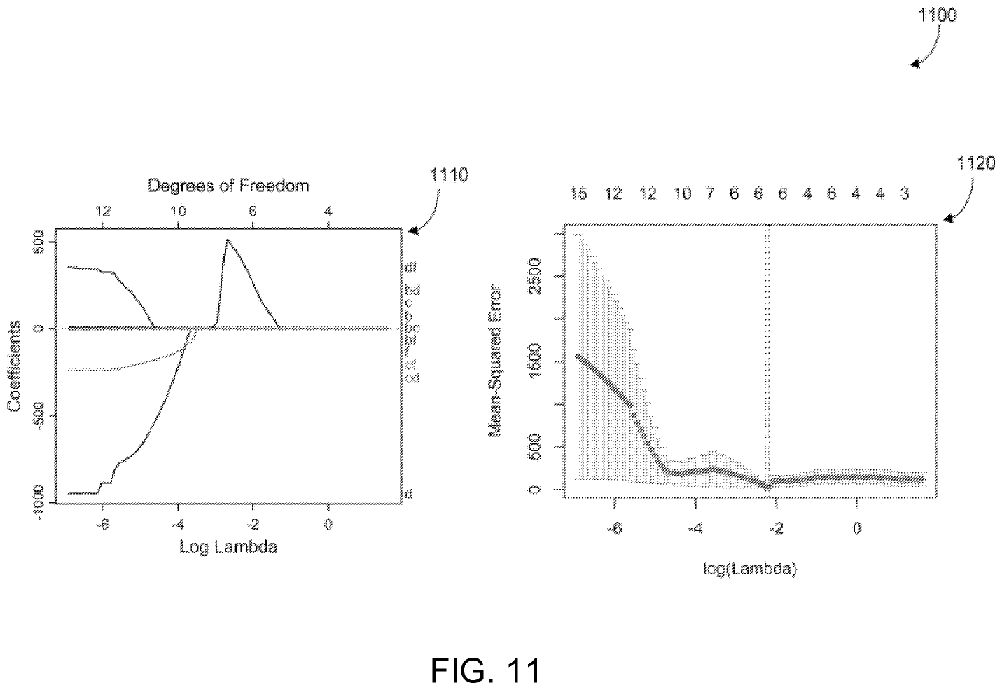

FIG. 11 includes example graphs 1100 that show determination of optimal physical variables that express printing quality. The left plot 1110 shows a Lasso path for determining the minimal variables with best fit to represent the total score of a print as a complex function in bath viscosity, ink viscosity, perturbation growth rate, pressure difference and retraction distance. Starting with the full basis set of 15 variables, Lasso increasingly suppressed regression coefficients as lambda was increased. The right graph 1120 shows a cross validation result plotting the validation mean squared prediction error (MSE) against lambda values. The dotted lines represent the value of lambda providing the balance between best-fit vs predictability. The Lasso trajectories are plotted as a function of the discriminating parameter X to identify combinations of middle-layer variables that best represent system responses shown in FIG. 11. The results of LOOCV show the mean-squared error plotted as a function of λ, which provides guidance on balancing overfitting (small X) and overfitting (large λ).

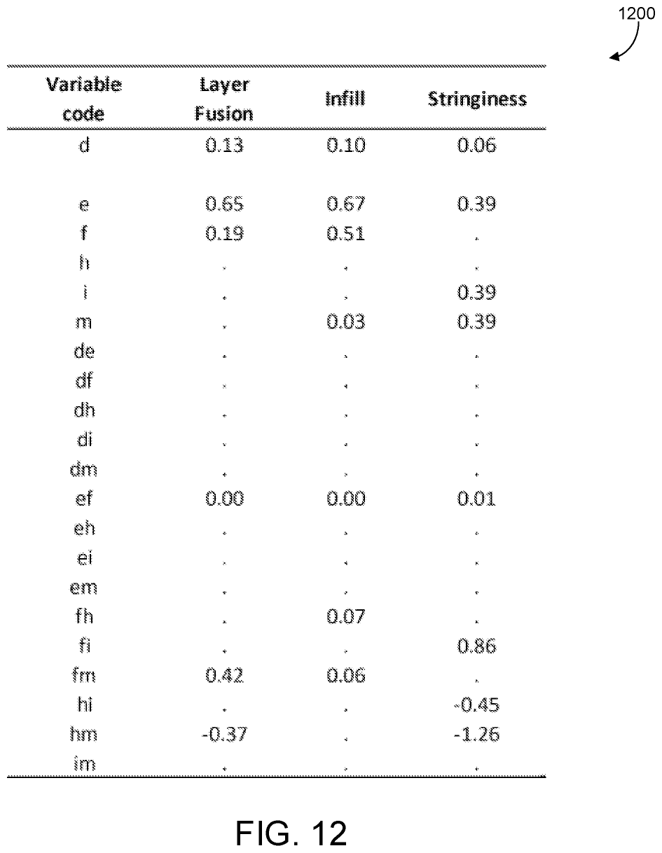

FIG. 12 shows a chart 1200 of system variables found to determine three metrics for print quality: layer fusion, infill, and stringiness. As stated above with respect to FIG. 6, Lasso regression used, gives insight into which parameters are statistically important for prediction by essentially eliminating the other parameters. From our regularized lasso regression results, we can see that each response variable depends differently on all of the system variables in both the type of variable as well as magnitude. For example, layer fusion seems to be affected more by ‘ink viscosity’, ‘bath yield stress/ink viscosity ratio−base thickness coupling’ and ‘rate of layer volume change base thickness coupling.’ than by other system variables. This enables creation of a master polynomial representing the system response, which under constrained optimization methods gives potential candidates for testing in the lab. This enables the machine-learning model to learn and improve in this context.

Before applying the HML algorithm, the training data relating print fidelity to the system variables were explored using Lasso. Steepest-descent methods are used to optimize the system variables by sequential, iterative analysis. Based on combinations of system variables and the corresponding printing score, the data were analyzed using Lasso, allowing for ranges of variables based on simulation constraints. Of particular importance was print speed, which was allowed to vary from 0 mm/s to 50 mm/s.

The results are tabulated in Table 4, below. It is seen that there is generally close agreement on the predictions of steepest-descent optimization and regularized regression, which suggests that the response surface established from this small training set was explored as accurately as possible using both methods.

TABLE 4
Comparison of determined system variable values for an un-
optimized best run and the HML prediction

| | | | Layer | Flow | Retraction | | |
|---|---|---|---|---|---|---|---|
| | Bath conc. | Ink viscosity | Height | rate | distance | | |
| | (w/v %) | (Pa · s) | (mm) | (mm/s) | (mm) | Bath material | Ink material |
| Steepest-descent | 0.01 | 3.50 | 0.9652 | 10 | 0.3 | Carbopol 940 | Sylgard 184 |
| optimization | | | | | | | |
| Lasso prediction | 0.01 | 3.50 | 0.974 | 10.47 | 0.53 | Carbopol 940 | Sylgard 184 |

As described above in reference to FIG. 2, the algorithm developed for optimization of the FRESH printing method can include the three tiered machine learning architecture. The top layer represents complex system responses to be optimized, which in FRESH are the three components of the scoring rubric that represent print fidelity. As noted, print speed is maximized by setting the ink flow rate and nozzle speed at to an allowed range of values and identifying parameter settings that maximize print speed while maintaining high print fidelity.

The central layer of the algorithm represents the physical forces and interactions that underlie print fidelity. These include the bath viscosity as a function of polymer concentration and specific viscosity, ink viscosity, the flow rate as a function of pressure drop. Initial versions of the algorithm did not include an interfacial tension force, which can result in Rayleigh instabilities and breakup of the silicone ink, but these were included in subsequent versions.

The bottom layer of the algorithm represents independent variables, some of which were discrete, such as the type of ink or bath material that was used, and some were continuous, such as bath concentration or ink flow rate. The algorithm handles each variable separately and ultimately parametrizes system responses as a function of all of them.

The algorithm was described in detail above. The complex system responses in the top layer are probed as a function of the system variables in the bottom layer. This generates the training set used in teaching the model. The constituent forces and interactions are then measured as a function of the system variables to provide parametrized expressions that relate system variables (bottom layer) to constituent forces (middle layer). Separately, the system responses (top layer) are statistically decomposed in terms of the values of the constituent forces using regularized regression. In hierarchical integration, the system responses are represented in terms of the system variables through re-parametrization. Then global maxima or minima can be identified subject to application-specific constraints to identify values of system variables that optimize system responses.

The final variables are presented in Eq. 12. The R software standardizes all variables by the ratio of difference from mean to the standard deviation before performing regularized regression then rescales the coefficients to their non-standardized values. This makes the relative magnitude of each coefficient unimportant; only the product of the coefficient and its variable determines the relative contribution to the system responses.

P=0.122η_{b}+5.349ηᵢ+2.227s−0.028η_{b}ηᵢ−0.004wΔp+344.3ws (12)

Variables and combinations of variables without a regression coefficient were found to have less predictive power than those that Lasso and LOOCV analyses retained. The magnitude of each coefficient that was included in the regression fit represented its relative contribution, and the sign indicated whether it was positively or negatively correlated with the scoring rubric that quantified print fidelity. For example, the bath and ink viscosities were positively correlated with print fidelity but the coupling between them was negatively correlated. This can be interpreted as predicting that increasing either ink or bath viscosity will improve print fidelity, possibly through reducing flow of the form prior to crosslinking, but the increasing both without bound would decrease printability and print fidelity.

The classes of variables that were retained by the Lasso trajectory. Only three single-variables were included: bath viscosity (ηb), ink viscosity (ηi), and retraction distance (s). However, the instability of the ink stream in the bath (w) and the pressure-drop across the needle (Δp) formed a composite variable based on their product and the fluid instability also coupled with the retraction distance. Thus, all independent variables were represented. However, the only term that coupled material variables and process variables was the product of fluid instability length and the retraction distance. This suggests that material and formulation variables form a related class while processing variables are a separate class. One potential implication of this is that the printing variables can be separately optimized from the material and formulation variables, which would allow for separate optimization of material feedstocks when applying the FRESH process to new systems.

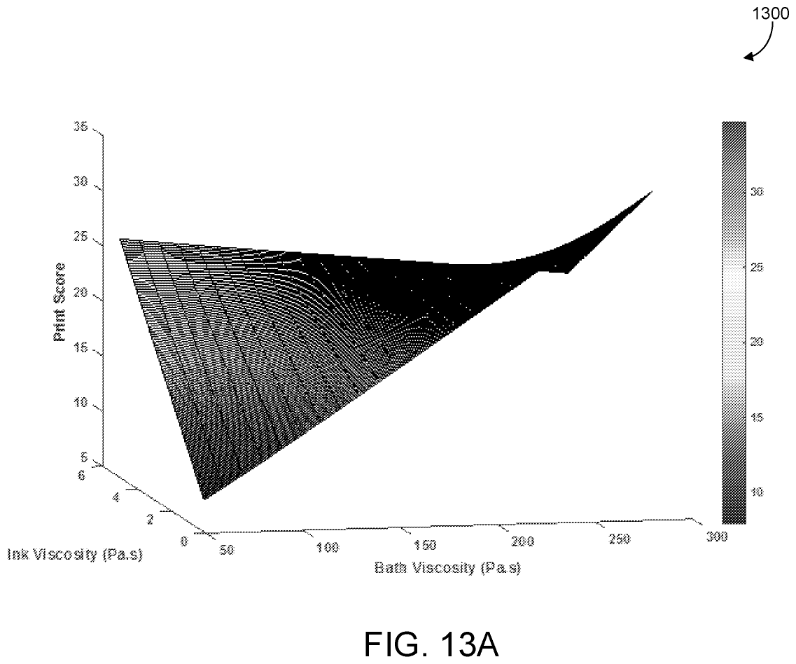

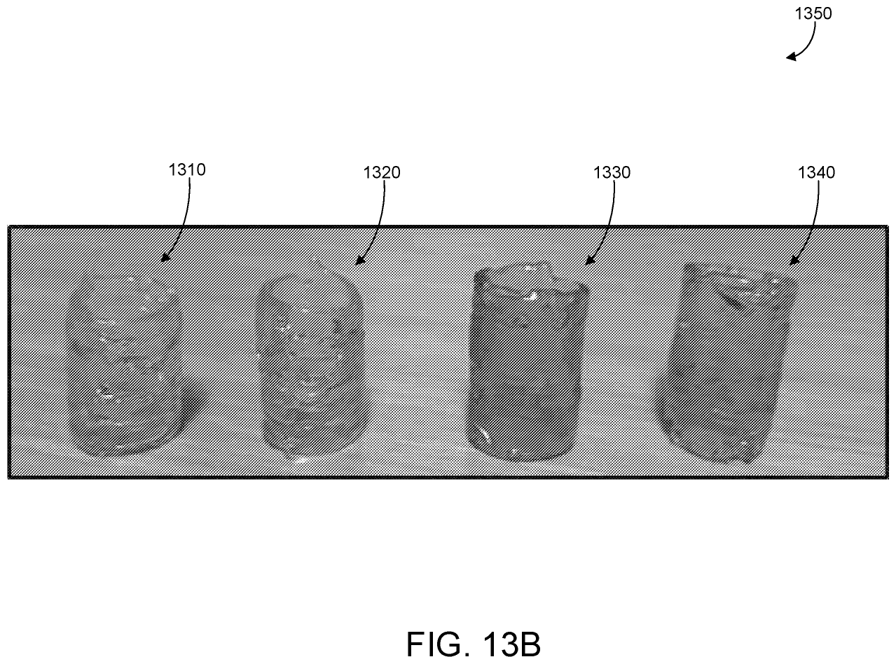

FIG. 13A shows determined system response surface 1300 by the data processing system. Optimization of the FRESH process for PDMS 3D printing can be accomplished through re-parametrization of the function representing print fidelity in terms of the underlying physical forces (Eq. 12) by the representation of these forces in terms of the independent variables. Then identification of global extrema identifies variable settings that maximize this function, subject to application constraints.

The system variables were represented as a six-dimensional vector (or 6-tuple) and the parametrized space for print fidelity P was therefore also six-dimensional. While print speed was determined by the independent variable Δp, optimization can be constrained to identify perfect scores (P=30) for print fidelity with the greatest value for Δp. Using the same bath and ink materials that were identified through previous optimization runs, HML identified values of bath concentration, layer height, and retraction distance that were predicted to result in maximum print scores with a print speed that was more than 2× greater than previous settings.

Printing low-viscosity inks is a challenge in FRESH, and the HML algorithm was then used to identify conditions for which high print fidelity can be obtained. The algorithm predicted that bath viscosity was an important factor in modulating the effects of low ink viscosity through the cross-term ηbηi in Eq. 12. The response surface for the print index as a function of bath and ink viscosities is shown in FIG. 11.

The response surface 1300 is generated from the final polynomial equation for Print score with respect to ink viscosity and bath viscosity while keeping needle size, flow rate and retraction distant constant at 0.9652 mm, 10 mm/s and 0.3 mm respectively (previous optimum vales). The results are tabulated in Table 5, below and representative prints are shown in FIG. 13B.

TABLE 5
Table of un-optimized system variables and predicted system variables
post constrained nonlinear minimization

| | Bath | Ink | Layer | Flow | Retraction | | |
|---|---|---|---|---|---|---|---|
| | conc. | viscosity | Height | rate | distance | Bath | |
| | (w/v %) | (Pa · s) | (mm) | (mm/s) | (mm) | material | Ink material |
| Steepest- | 0.01 | 3.50 | 0.9652 | 10 | 0.3 | Carbopol | Sylgard 184 |
| descent | | | | | | 940 | |
| optimization | | | | | | | |
| HML | 0.012 | 3.50 | 0.93 | 22.71 | 0.64 | Carbopol | Sylgard 184 |
| prediction 1 | | | | | | 940 | |
| HML | 0.008 | 0.42 | 1.27 | 25.98 | 0.49 | Carbopol | Dow Corning |
| prediction 2 | | | | | | 940 | 3-4241 |

FIG. 13B shows example created 3D printed structures 1310 using varying system variable values determined by the data processing system. The first two prints are previous best runs for Dow-Corning 3-4241 ink using settings identified during steepest-descent analysis, and the two forms at the right are those from HML prediction 2 for the same ink.

The data processing system has adapted machine-learning methods for analyzing and making predictions based on small datasets, which is critical for advancing research in complex material systems. Further, the data processing system can also be used for optimizing formulations and processing in a wide variety of applications. Example applications of material formulations, material compositions, and processes that can be developed, in addition to the 3D-printing process and material and polymeric dispersant formulation implementations described above, include asphalt composition, herbicide formulations and non-ionic surfactants, paint formulations, automotive coatings, and so forth.

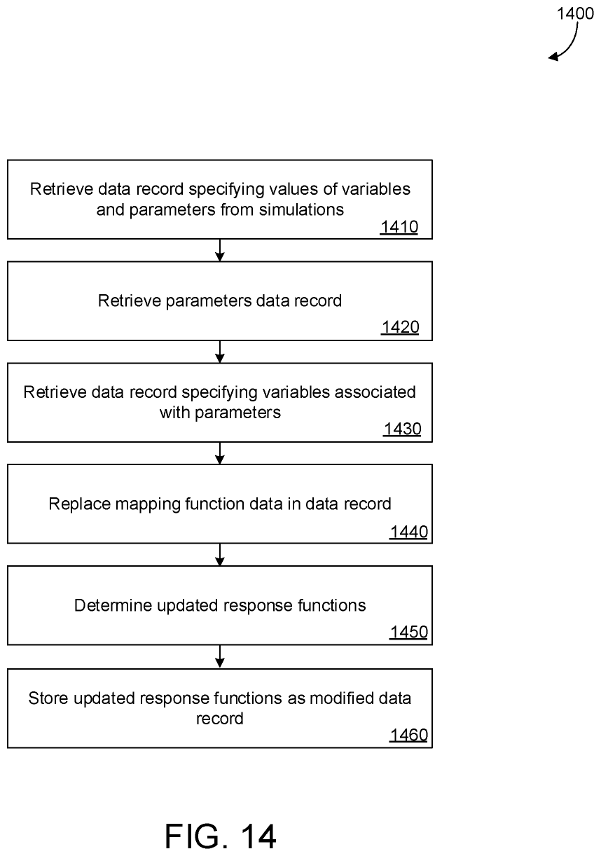

FIG. 14 is a flow diagram 1400 showing an example process for determining responses of a system using the data processing system 100. The data processing system retrieves (1410), from the plurality of fourth data records, a fourth data record specifying particular values of at least two selected variables implemented in a particular simulation and a particular value of at least one parameter output from the simulation. The data processing system retrieves (1420), from the plurality of second data records, a second data record specifying the at least one parameter that is output. The data processing system retrieves (1430), from the plurality of third data records, a third data record comprising at least one of the at least two selected variables assigned to the at least one parameter that is output. The data processing system replaces (1440) a value of a given field in the second data record, with the given field representing a mapping function specified by the second data record, with the replaced value being based on the at least one parameter specified by the second data record, the at least one of the at least two selected variables of the third data record, and the particular values of the at least two selected variables implemented in the particular simulation and the particular value of the at least one parameter output of the fourth data record. The data processing system, based on the replaced value of the field in the second data record, determines (1450) updated responses for the one or more properties of the composition of the material. The data processing system stores (1460), in the plurality of first data records, the updated responses for respective properties of the composition of the material as a modified set of first data records.

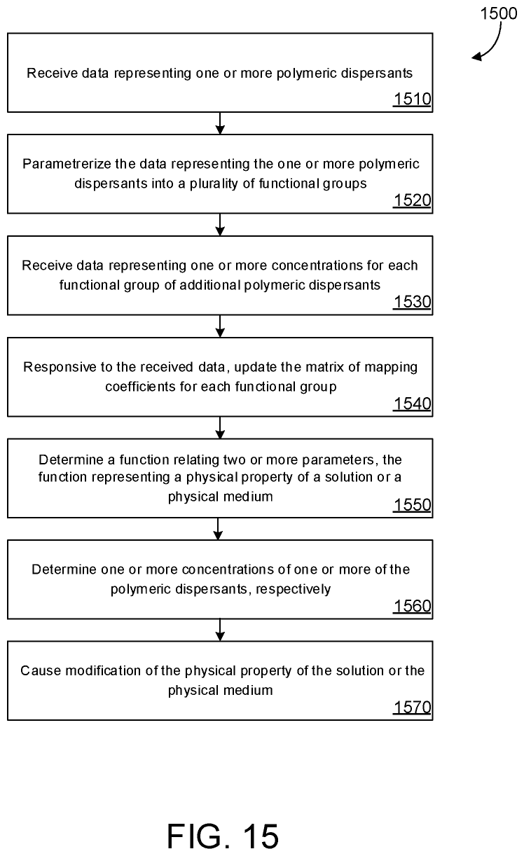

FIG. 15 is a flow diagram 1500 showing an example process for determining the composition of a suspension mixture using the data processing system 100. The data processing system receives (1510) data representing one or more polymeric dispersants. The data processing system parameterizes (1520) the data representing the one or more polymeric dispersants into a plurality of functional groups, each functional group mapped, in accordance with a matrix of mapping coefficients, to at least one of the one or more polymeric dispersants. The data processing system receives (1530) data representing one or more concentrations for each functional group of one or more additional polymeric dispersants. The data processing system, responsive to the received data, updates (1540) the matrix of mapping coefficients for each functional group. The data processing system determines (1550), based on the updated matrix for each functional group, a function relating two or more parameters, the function representing a physical property of a solution or a physical medium. The data processing system determines (1560), based on applying a linear regression to the function, one or more concentrations of one or more of the polymeric dispersants, respectively. The data processing system causes (1560) modification of the physical property of the solution or the physical medium, with the modification being in accordance with the one or more concentrations of the one or more polymeric dispersants.

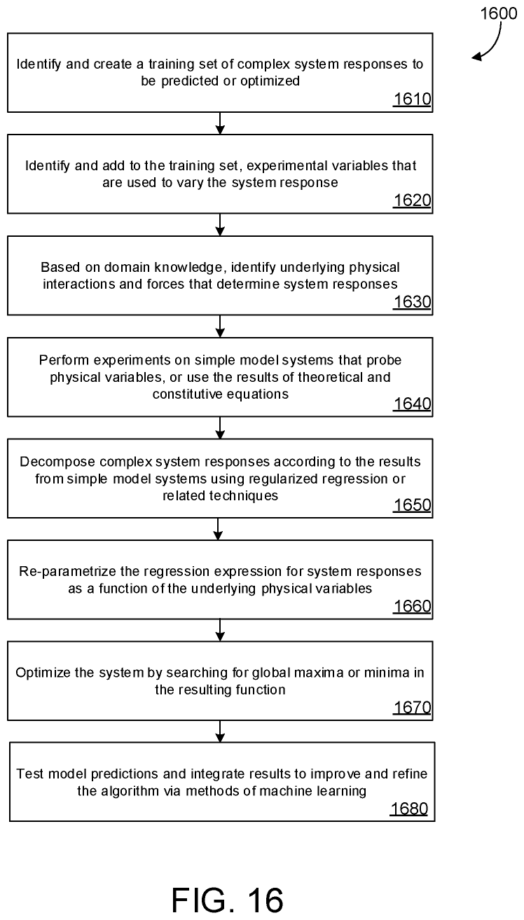

FIG. 16. is a flow diagram 1600 showing an example process for determining responses of a system using the data processing system 100. The data processing system identifies and creates (1610) a training set of complex system responses to be predicted or optimized. For example, this could be measuring the viscosity of a concentrated suspension. The suspension viscosity would be the system response to be optimized. The data processing system identifies and adds (1620) to the training set, system variables that are used to vary the system response. For example, this could be screening the effects of a library of polymer dispersants having a diversity of compositions on the suspension viscosity. The data processing system, based on domain knowledge, identifies (1630) underlying physical interactions and forces that determine system responses (e.g., dispersants function via tuning both particle and pore-solution characteristics). In the case of the effects of polymer dispersants, the suspension viscosity is fundamentally a function of the solution viscosity and osmolality, and the steric and electrostatic interactions between the particles. The data processing system performs simulations (1640) on simple model systems that probe physical variables, uses the results of theoretical and constitutive equations, or uses physical experiments of the underlying physical interactions and forces, to develop parametrized expressions that relate system variables to underlying physical variables. For example, the solution osmolality can be measured as a function of the concentration of each polymer, and an estimate for the solution osmotic pressure in the concentrated suspension can be developed based on knowledge of the partitioning of the polymer between free and adsorbed states. The data processing system decomposes (1650) complex system responses according to the results from simple model systems using regularized regression or related techniques. For example, the Lasso regression method can be used to identify the constituent interactions and forces (and their combinations) that most strongly determine (i.e. are most strongly correlated with) the system responses. This results in an equation for the system response (suspension viscosity) in terms of the constituent interactions and forces that most strongly determine these responses. The data processing system re-parametrizes (1660) the regression expression for system responses as a function of the underlying physical variables by writing expressions for the underlying physical variables in terms of the system variables. In this case, the functional dependence of the solution osmolality on polymer composition is used to convert from a representation of suspension viscosity in terms of constituent interactions and forces to a representation in terms of system variables, such as polymer compositions. The data processing system optimizes (1670) the system by searching for global maxima or minima in the resulting function for system responses in terms of system variables. The data processing system tests (1680) model predictions and integrate results to improve and refine the algorithm via methods of machine learning, such as using recurrent neural networks.

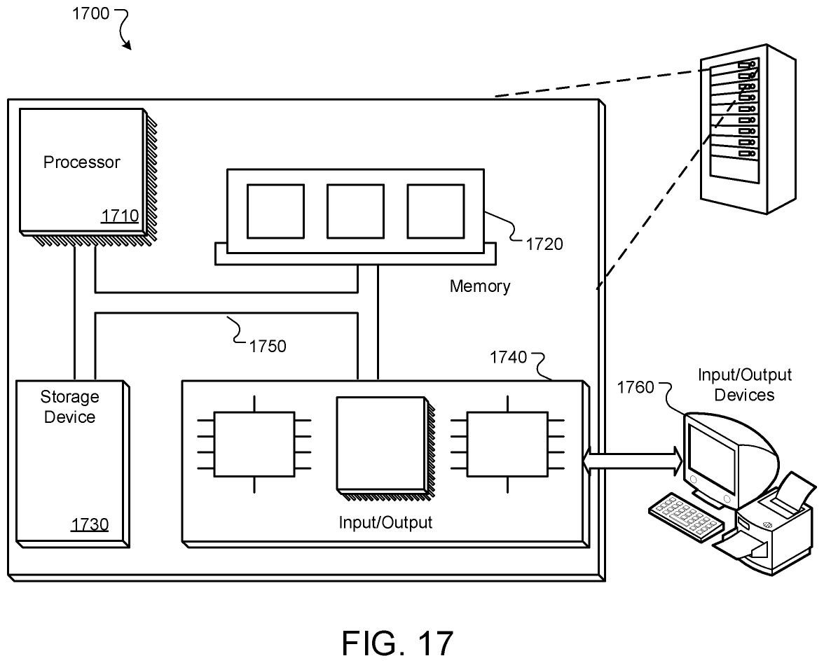

FIG. 17 is a block diagram of an example computer system 1700. For example, referring to FIG. 1, the data processing system 100 could be an example of the system 1700 described here, as could a computer system used by any of the users who access resources of one or more databases, as shown in FIG. 1. The system 1700 includes a processor 1710, a memory 1720, a storage device 1730, and one or more input/output interface devices 1740. Each of the components 1710, 1720, 1730, and 1740 can be interconnected, for example, using a system bus 1750.

The processor 1710 is capable of processing instructions for execution within the system 1700. The term “execution” as used here refers to a technique in which program code causes a processor to carry out one or more processor instructions. In some implementations, the processor 1710 is a single-threaded processor. In some implementations, the processor 1710 is a multi-threaded processor. In some implementations, the processor 1710 is a quantum computer. The processor 1710 is capable of processing instructions stored in the memory 1720 or on the storage device 1730. The processor 1710 may execute operations such as designing a composition of a material.

The memory 1720 stores information within the system 1700. In some implementations, the memory 1720 is a computer-readable medium. In some implementations, the memory 1720 is a volatile memory unit. In some implementations, the memory 1720 is a non-volatile memory unit.

The storage device 1730 is capable of providing mass storage for the system 1700. In some implementations, the storage device 1730 is a non-transitory computer-readable medium. In various different implementations, the storage device 1730 can include, for example, a hard disk device, an optical disk device, a solid-state drive, a flash drive, magnetic tape, or some other large capacity storage device. In some implementations, the storage device 1730 may be a cloud storage device, e.g., a logical storage device including one or more physical storage devices distributed on a network and accessed using a network. In some examples, the storage device may store long-term data, such as the data records 130, 140, 150, 170, 170, as shown in FIG. 1. The input/output interface devices 1740 provide input/output operations for the system 1700. In some implementations, the input/output interface devices 1740 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 1700 to communicate, for example, transmit and receive data. In some implementations, the input/output device can include driver devices configured to receive input data and send output data to other input/output devices, e.g., keyboard, printer and display devices 1760. In some implementations, mobile computing devices, mobile communication devices, and other devices can be used.

Referring to FIG. 1, processing of the data records can be realized by instructions that upon execution cause one or more processing devices to carry out the processes and functions described above, for example, designing a composition of a material. Such instructions can include, for example, interpreted instructions such as script instructions, or executable code, or other instructions stored in a computer readable medium.

A data processing system, as shown in FIG. 1 can be distributively implemented over a network, such as a server farm, or a set of widely distributed servers or can be implemented in a single virtual device that includes multiple distributed devices that operate in coordination with one another. For example, one of the devices can control the other devices or the devices may operate under a set of coordinated rules or protocols, or the devices may be coordinated in another fashion. The coordinated operation of the multiple distributed devices presents the appearance of operating as a single device.

In some examples, the system 1700 is contained within a single integrated circuit package. A system 1700 of this kind, in which both a processor 1710 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 1740.

Although an example processing system has been described in FIG. 17, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine-readable storage device, a machine-readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server is a general-purpose computer, sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The details of one or more embodiments of the data processing system are set forth in the accompanying drawings and the description below. Other features, objects, and advantages of the data processing system describe herein will be apparent from the description and drawings, and from the claims.

What is claimed is:

1. A data processing system for processing data records in designing a formulation of a material comprising:
a hardware storage device storing:
a plurality of first data records each specifying one or more responses for one or more properties of the composition of the material;
a plurality of second data records each specifying one or more parameters and further including, for each of the one or more parameters, a field with one or more values specifying a mapping function that assigns that that parameter to a plurality of variables;
a plurality of third data records each specifying at least one of the variables;
a plurality of fourth data records each specifying i) a value for each of at least two selected variables implemented in a simulation, and ii) a value of at least one parameter output from the simulation, with the at least one parameter being assigned to each of the at least two selected variables;
one or more processors configured to perform operations comprising:
retrieving, from the plurality of fourth data records, a fourth data record specifying particular values of at least two selected variables implemented in a particular simulation and a particular value of at least one parameter output from the simulation;
retrieving, from the plurality of second data records, a second data record specifying the at least one parameter that is output;
retrieving, from the plurality of third data records, a third data record comprising at least one of the at least two selected variables assigned to the at least one parameter that is output;
replacing a value of a given field in the second data record, with the given field representing a mapping function specified by the second data record, with the replaced value being based on the at least one parameter specified by the second data record, the at least one of the at least two selected variables of the third data record, and the particular values of the at least two selected variables implemented in the particular simulation and the particular value of the at least one parameter output of the fourth data record;
based on the replaced value of the field in the second data record, determining updated responses for the one or more properties of the composition of the material; and
storing, in the plurality of first data records, the updated responses for respective properties of the composition of the material as a modified set of first data records.

2. The data processing system of claim 1, further comprising a sub-system configured to:
determine, based on the updated responses, one or more new values for at least one of the properties of the composition of the material; and
cause modification of the composition of the material, with the modification being in accordance with the one or more new values for the at least one of the properties.

3. The data processing system of claim 1, further comprising:
a sub-system that determines, based on the updated responses, one or more new values for at least one of the properties of the composition of the material; and
an entity that modifies the composition of the material, with the modification being in accordance with the one or more new values for the at least one of the properties.

4. The data processing system of claim 1, replacing the value of a given field in the second data record comprises applying a machine learning model that uses the at least one parameter specified by the second data record, the at least one of the at least two selected variables of the third data record, and the particular values of the at least two selected variables implemented in the particular simulation and the particular value of the at least one parameter output of the fourth data record.

5. The data processing system of claim 4, wherein the machine-learning model comprises a recurrent neural network.

6. The data processing system of claim 1, wherein determining the updated responses for the properties of the material comprises applying a linear regression model to the value of the field of each of the plurality of second data records.

7. The data processing system of claim 1, further comprising a machine learning engine, wherein the plurality of fourth data records comprise a training set for the machine learning engine.

8. The data processing system of claim 1, wherein the simulation comprises one or more of physical interactions, digital simulations, and analytical models.

9. The data processing system of claim 1, wherein the at least one of the two selected variables of the third data record represents a polymeric dispersant formulation.

10. The data processing system of claim 1, wherein the at least one of the two selected variables of the third data record represents one of a bath concentration, bath material, ink material, printer flow rate, filament packing density ratio, retraction distance, layer height, and needle thickness.

11. The data processing system of claim 1, wherein the at least one parameter of the second data record represents a functional group of one or more polymeric dispersants, and wherein a value of the at least one parameter represents a mole fraction of the functional group of one or more polymeric dispersants.

12. The data processing system of claim 1, wherein a response specifies one or more of viscosity, osmolality, particle sedimentation, and particle zeta potential.

13. The data processing system of claim 1, wherein a response specifies one or more of layer fusion, infill value, and stringiness.

14. The data processing system of claim 1, wherein the given field representing the mapping function comprises a matrix of coefficient values that correlate the at least one parameter to the at least two selected variables.

15. The data processing system of claim 1, wherein at least one of the updated responses for respective properties of the composition of the material represents a function of the at least one parameter of the second data record.

16. The data processing system of claim 1, wherein the at least one of the two selected variables of the third data record represents a surfactant formulation.

17. The data processing system of claim 1, wherein determining the updated responses for the properties of the material comprises applying a symbolic regression model to the value of the field of each of the plurality of second data records.

18. A computer-implemented method for processing data records in designing a composition of a material, comprising:
accessing a plurality of first data records each specifying one or more responses for one or more properties of the composition of the material;
accessing a plurality of second data records each specifying one or more parameters and further including, for each of the one or more parameters, a field with one or more values specifying a mapping function that assigns that that parameter to a plurality of variables;
accessing a plurality of third data records each specifying at least one of the variables;
accessing a plurality of fourth data records each specifying i) a value for each of at least two selected variables implemented in a simulation, and ii) a value of at least one parameter output from the simulation, with the at least one parameter being assigned to each of the at least two selected variables;
retrieving, from the plurality of fourth data records, a fourth data record specifying particular values of at least two selected variables implemented in a particular simulation and a particular value of at least one parameter output from the simulation;
retrieving, from the plurality of second data records, a second data record specifying the at least one parameter that is output;
retrieving, from the plurality of third data records, a third data record comprising at least one of the at least two selected variables assigned to the at least one parameter that is output;
replacing a value of a given field in the second data record with the given field representing a mapping function specified by the second data record, with the replaced value being based on the at least one parameter specified by the second data record, the at least one of the at least two selected variables of the third data record, and the particular values of the at least two selected variables implemented in the particular simulation and the particular value of the at least one parameter output of the fourth data record;
based on the replaced value of the field in the second data record, determining updated responses for the one or more properties of the composition of the material; and
storing, in the plurality of first data records, the updated responses for respective properties of the composition of the material as a modified set of first data records.

19. The computer-implemented method of claim 18, comprising determining, based on the updated responses, one or more new values for at least one of the properties of the composition of the material.

20. The computer-implemented method of claim 19, comprising causing modification of the composition of the material, with the modification being in accordance with the one or more new values for the at least one of the properties.

21. The computer-implemented method of claim 19, comprising modifying of the composition of the material, with the modification being in accordance with the one or more new values for the at least one of the properties.

22. The computer-implemented method of claim 18, replacing the value of a given field in the second data record comprises applying a machine learning model that uses the at least one parameter specified by the second data record, the at least one of the at least two selected variables of the third data record, and the particular values of the at least two selected variables implemented in the particular simulation and the particular value of the at least one parameter output of the fourth data record.

23. The computer-implemented method of claim 22, wherein the machine-learning model comprises a recurrent neural network.

24. The computer-implemented method of claim 18, wherein determining the updated responses for the properties of the material comprises applying a linear regression model to the value of the field of each of the plurality of second data records.

25. The computer-implemented method of claim 18, further comprising a machine learning engine, wherein the plurality of fourth data records comprise a training set for the machine learning engine.

26. The computer-implemented method of claim 18, wherein the simulation comprises one or more of physical interactions, digital simulations, and analytical models.

27. The computer-implemented method of claim 18, wherein the at least one of the two selected variables of the third data record represents a polymeric dispersant composition.

28. The computer-implemented method of claim 18, wherein the at least one parameter of the second data record represents a functional group of one or more polymeric dispersants, and wherein a value of the at least one parameter represents a mole fraction of the functional group of one or more polymeric dispersants.

29. The computer-implemented method of claim 18, wherein at least one of the updated responses for respective properties of the composition of the material represents a function of the at least one parameter of the second data record.

30. A method for designing a formula for a suspension mixture, the method comprising:
receiving data representing one or more polymeric dispersants;
parameterizing the data representing the one or more polymeric dispersants into a plurality of functional groups, each functional group mapped, in accordance with a matrix of mapping coefficients, to at least one of the one or more polymeric dispersants;
receiving data representing one or more concentrations for each functional group of one or more additional polymeric dispersants;
responsive to the received data, updating the matrix of mapping coefficients for each functional group;
determining, based on the updated matrix for each functional group, a function relating two or more parameters, the function representing a physical property of a solution or a physical medium;
determining, based on applying a linear regression to the function, one or more concentrations of one or more of the polymeric dispersants, respectively; and
causing modification of the physical property of the solution or the physical medium, with the modification being in accordance with the one or more concentrations of the one or more polymeric dispersants.
